(19) United States
(12) Patent Application Publication
(10) Pub. No.: US 2013/0055119 A1
(43) Pub. Date: Feb. 28, 2013

(54) Device, Method, and Graphical User Interface for Variable Speed Navigation

(71) Applicant: Anh Luong, Santa Clara, CA (US)

(72) Inventor: Anh Luong, Santa Clara, CA (US)

(21) Appl. No.: 13/216,196

(22) Filed: Aug. 23, 2011

(51) Int. Cl. G06F 3/048

(52) U.S. Cl. 715/764

(57) ABSTRACT

An electronic device displays a first page in a set of pages on a display; detects a first gesture at a location on a touch-sensitive surface corresponding to a predefined area on the display; in response to detecting the first gesture, displays a navigation object in proximity to the predefined area; detects a second gesture on the touch-sensitive surface with respect to the navigation object; and in response to detecting the second gesture, performs a navigation operation with respect to the first page at a specified velocity and in accordance with a direction of the second gesture. The velocity of the operation is based on a condition of the second gesture with respect to the navigation object.

### TECHNICAL FIELD

This relates generally to electronic devices with touch-sensitive surfaces, including but not limited to electronic devices with touch-sensitive surfaces that are used to navigate through a user interface at variable speeds.

### BACKGROUND

The use of touch-sensitive surfaces as input devices for computers and other electronic computing devices has increased significantly in recent years. Exemplary touch-sensitive surfaces include touch pads and touch screen displays. Such surfaces are widely used to navigate through user interfaces on a display.

Exemplary navigations include moving between pages in a multipage user interface and zooming in or out in a camera user interface with a live preview. But existing methods for performing these navigations are cumbersome and inefficient. For example, to navigate between multiple pages quickly, the user has to apply multiple, quick physical inputs, which may be physically demanding for some people, and may be otherwise inconvenient in some situations. In addition, existing methods take longer than necessary, thereby wasting energy. This latter consideration is particularly important in battery-operated devices.

### SUMMARY

Accordingly, there is a need for electronic devices with faster, more efficient methods and interfaces for navigating through user interfaces. Such methods and interfaces may complement or replace conventional methods for navigating through user interfaces. Such methods and interfaces reduce the cognitive burden on a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device has a touchpad. In some embodiments, the device has a touch-sensitive display (also known as a “touch screen” or “touch screen display”). In some embodiments, the device has a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive surface. In some embodiments, the functions may include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a non-transitory computer readable storage medium or other computer program product configured for execution by one or more processors.

In accordance with some embodiments, a method is performed at an electronic device with a display and a touch-sensitive surface. The method includes: displaying a first page in a set of pages on the display; detecting a first gesture at a location on the touch-sensitive surface corresponding to a predefined area on the display; in response to detecting the first gesture, displaying a navigation object in proximity to the predefined area; detecting a second gesture on the touch-sensitive surface with respect to the navigation object; and in response to detecting the second gesture, performing a navigation operation with respect to the first page at a specified velocity and in accordance with a direction of the second gesture, where the velocity of the operation is based on a condition of the second gesture with respect to the navigation object.

In accordance with some embodiments, a method is performed at an electronic device with a display and a touch-sensitive surface. The method includes: displaying a camera interface on the display, including displaying a live image preview in a viewfinder area in the camera interface; detecting a first gesture at a location on the touch-sensitive surface corresponding to a predefined area in the camera interface; in response to detecting the first gesture, displaying a first function object in proximity to the predefined area; detecting a second gesture on the touch-sensitive surface with respect to the first function object; and in response to detecting the second gesture, zooming the live image preview at a specified velocity and in accordance with a direction of the second gesture, where the velocity of the zooming is based on a condition of the second gesture with respect to the first function object.

In accordance with some embodiments, an electronic device includes a display, a touch-sensitive surface, one or more processors, memory, and one or more programs; the one or more programs are stored in the memory and configured to be executed by the one or more processors and the one or more programs include instructions for performing the operations of any of the methods described above. In accordance with some embodiments, a graphical user interface on an electronic device with a display, a touch-sensitive surface, a memory, and one or more processors to execute one or more programs stored in the memory includes one or more of the elements displayed in any of the methods described above, which are updated in response to inputs, as described in any of the methods above. In accordance with some embodiments, a computer readable storage medium has stored therein instructions which when executed by an electronic device with a display, a touch-sensitive surface, cause the device to perform the operations of any of the methods described above. In accordance with some embodiments, an electronic device includes: a display, a touch-sensitive surface; and means for performing the operations of any of the methods described above. In accordance with some embodiments, an information processing apparatus, for use in an electronic device with a display and a touch-sensitive surface, includes means for performing the operations of any of the methods described above.

In accordance with some embodiments, an electronic device includes a display unit configured to display a first page in a set of pages; a touch-sensitive surface unit configured to receive gestures; and a processing unit coupled to the display unit and the touch-sensitive surface unit. The processing unit is configured to detect a first gesture at a location on the touch-sensitive surface unit corresponding to a predefined area on the display unit; in response to detecting the first gesture, enable display of a navigation object in proximity to the predefined area; detect a second gesture on the touch-sensitive surface unit with respect to the navigation object; and in response to detecting the second gesture, perform a navigation operation with respect to the first page at a specified velocity and in accordance with a direction of the second gesture, wherein the velocity of the operation is based on a condition of the second gesture with respect to the navigation object.

In accordance with some embodiments, an electronic device includes a display unit configured to display a camera interface, including a live image preview in a viewfinder area in the camera interface; a touch-sensitive surface unit configured to receive gestures; and a processing unit coupled to the display unit and the touch-sensitive surface unit. The processing unit is configured to detect a first gesture at a location on the touch-sensitive surface unit corresponding to a predefined area in the camera interface; in response to detecting the first gesture, enable display of a first function object in proximity to the predefined area; detect a second gesture on the touch-sensitive surface unit with respect to the first function object; and in response to detecting the second gesture, zoom the live image preview at a specified velocity and in accordance with a direction of the second gesture, wherein the velocity of the zooming is based on a condition of the second gesture with respect to the first function object.

Thus, electronic devices with displays and touch-sensitive surfaces are provided with faster, more efficient methods and interfaces for navigating through user interfaces, thereby increasing the effectiveness, efficiency, and user satisfaction with such devices. Such methods and interfaces may complement or replace conventional methods for navigating through user interfaces.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5P illustrate exemplary user interfaces for navigating and zooming at variable speeds in accordance with some embodiments.

FIGS. 6A-6C are flow diagrams illustrating a method of navigating through pages at variable speeds in accordance with some embodiments.

FIGS. 7A-7B are flow diagrams illustrating a method of zooming an image preview in accordance with some embodiments.

FIGS. 8-9 are functional block diagrams of electronic devices in accordance with some embodiments.

### DESCRIPTION OF EMBODIMENTS

Many electronic devices have user interface navigation operations that may be activated multiple times in succession, such as navigating between pages, moving a cursor or marker, or zooming in and out of an image. A user may wish to have such an operation performed multiple times at different speeds in order to quickly reach a desired result. Existing methods typically repeat these operations at a single speed, or perform them as fast as the user can activate them. In the embodiments, described below, a more efficient method for performing such operations at different speeds is achieved by displaying, in response to a user input at a predefined location, a user interface object. A gesture is performed with respect to the user interface object. In response to the gesture, the operation is performed repeatedly at a specified speed. The specified speed is based on a condition of the gesture with respect to the user interface object (e.g., a position of the contact in the gesture with respect to the user interface object).

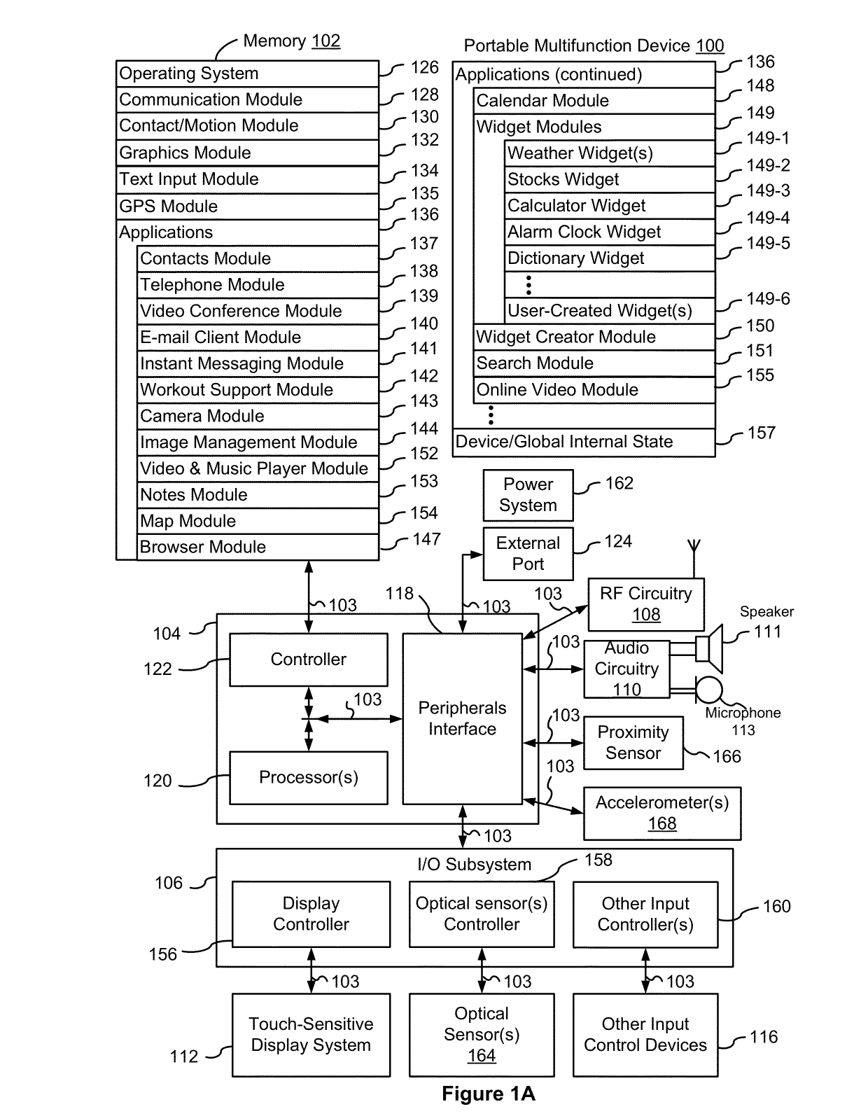

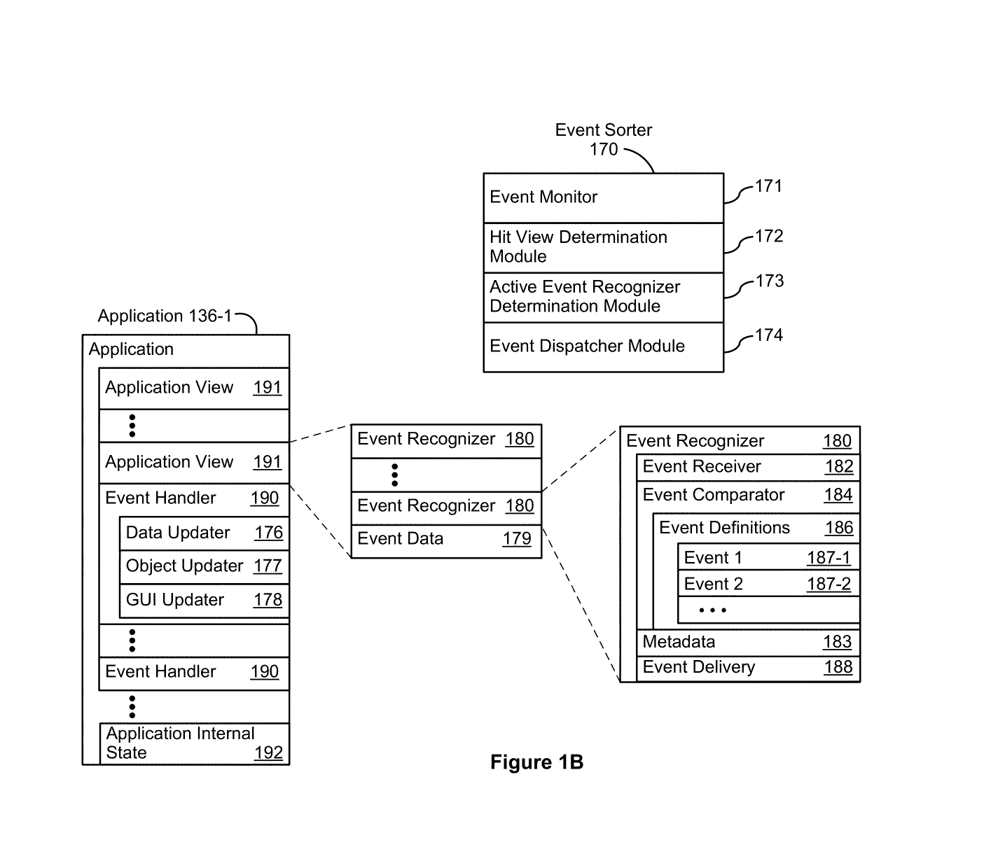

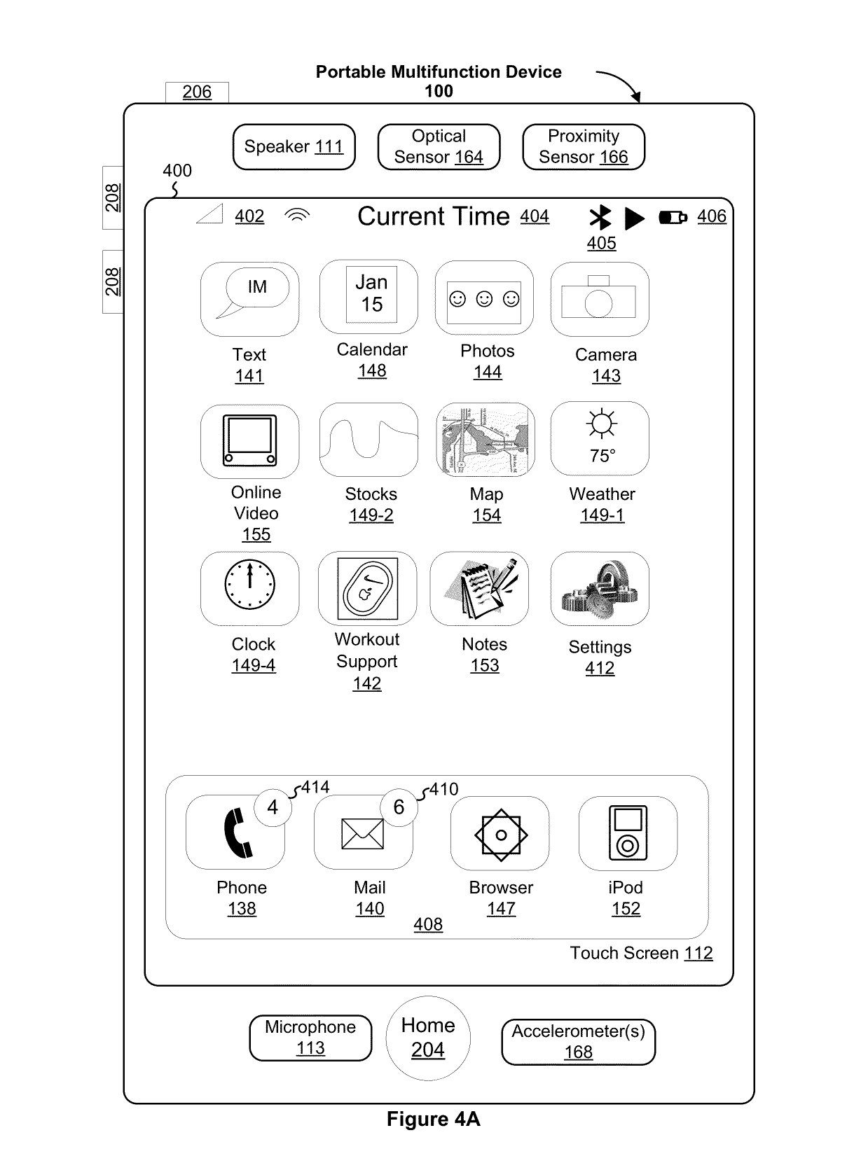

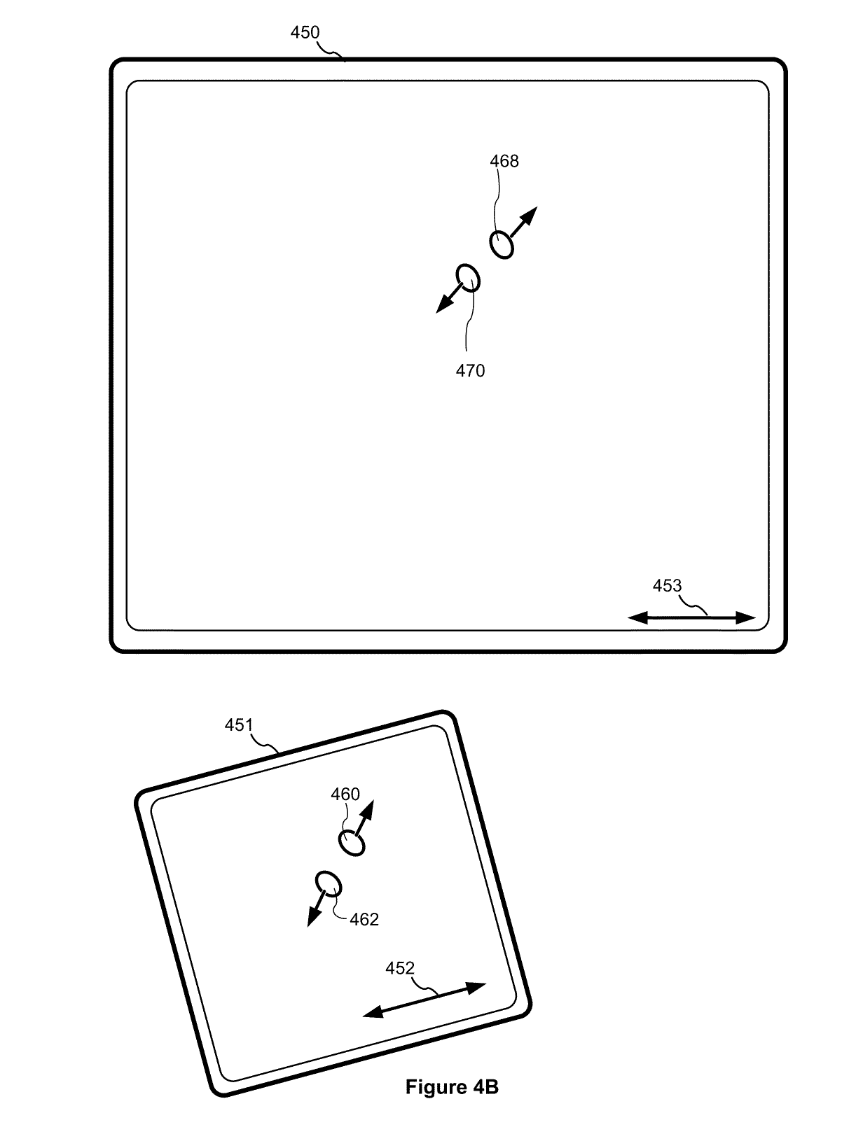

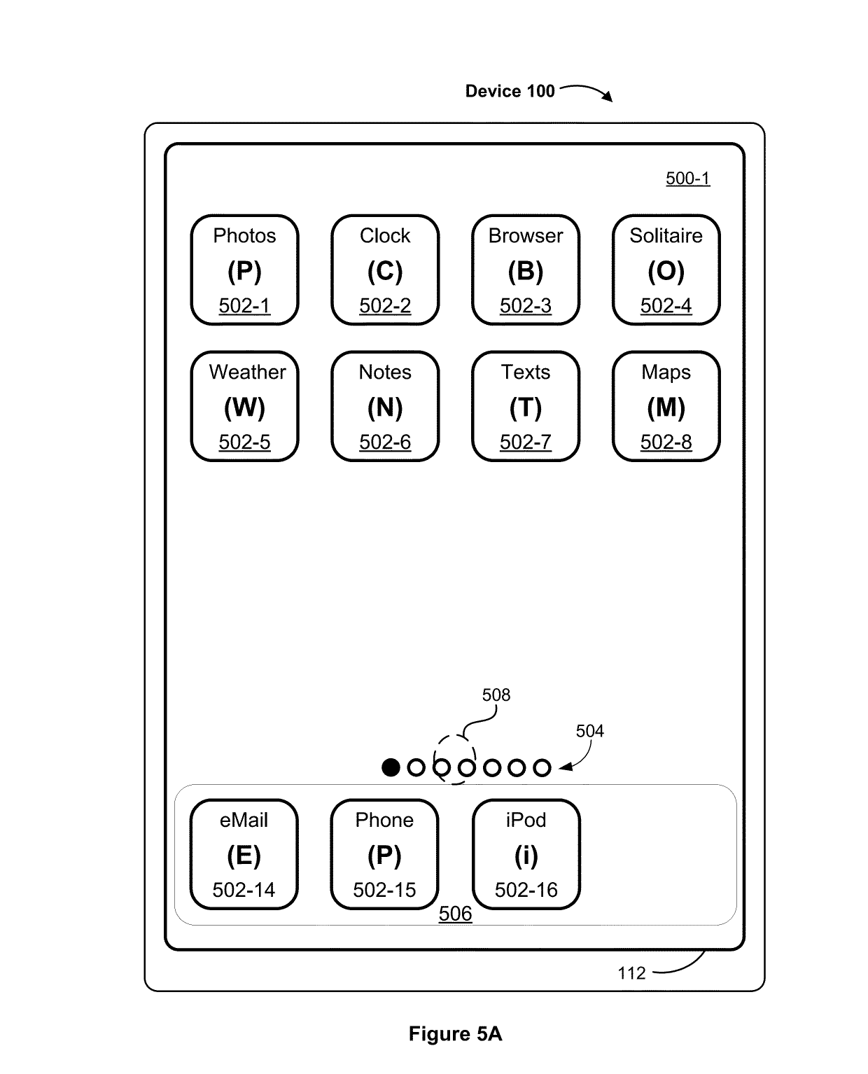

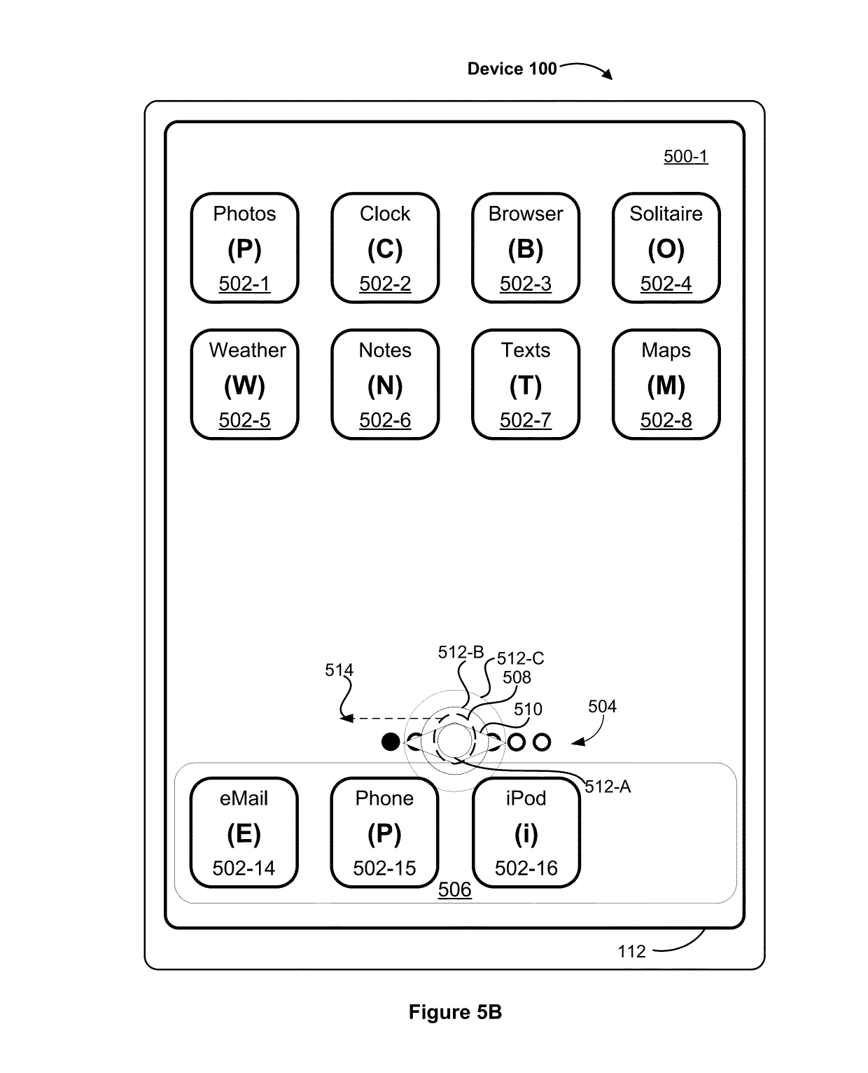

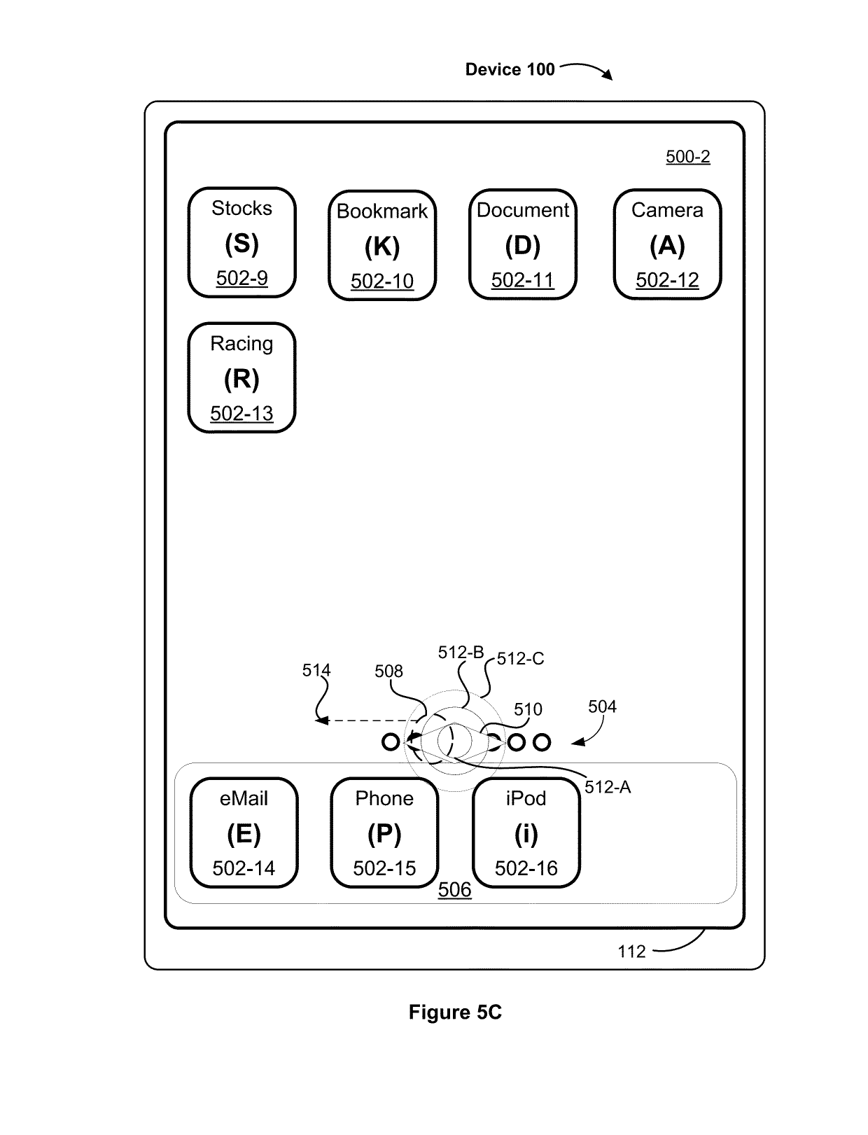

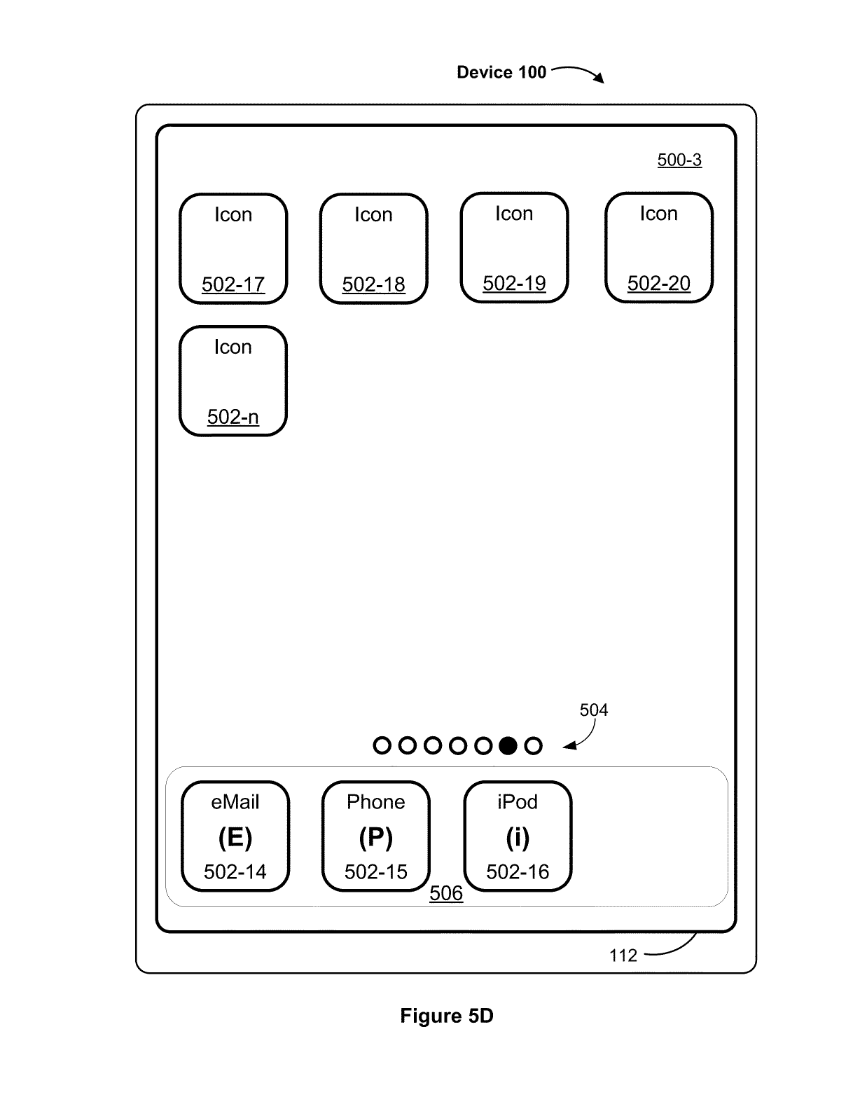

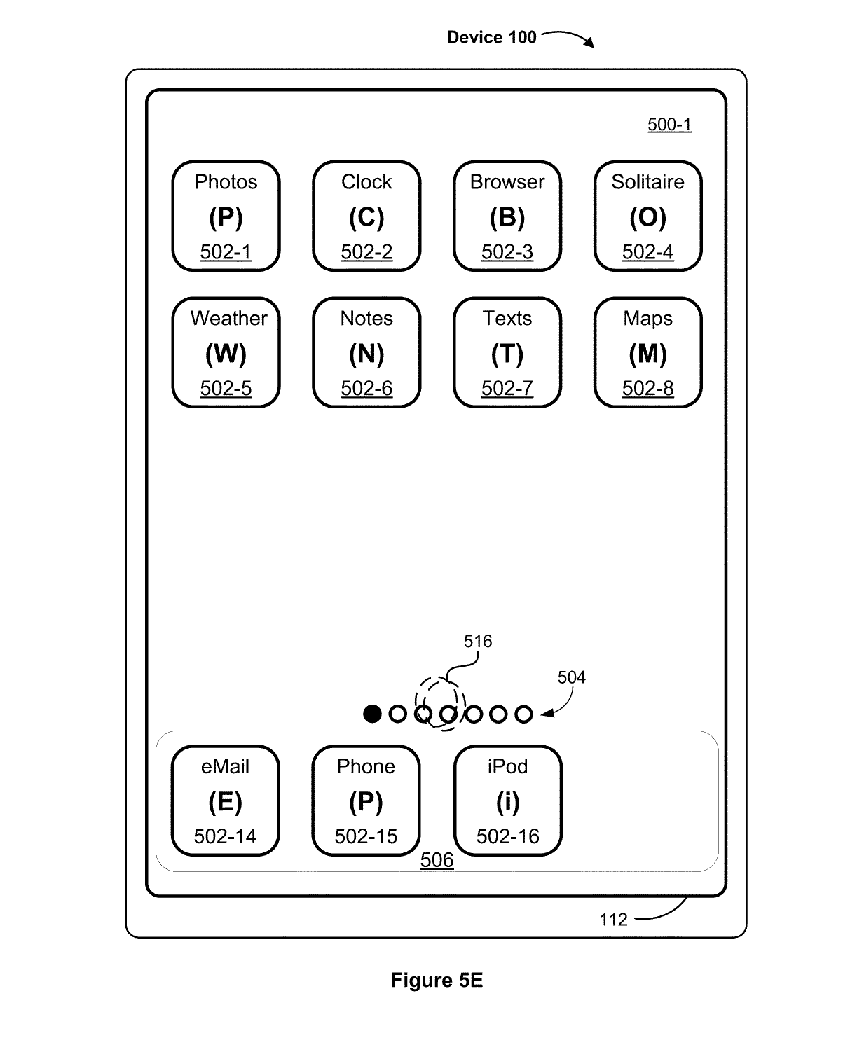

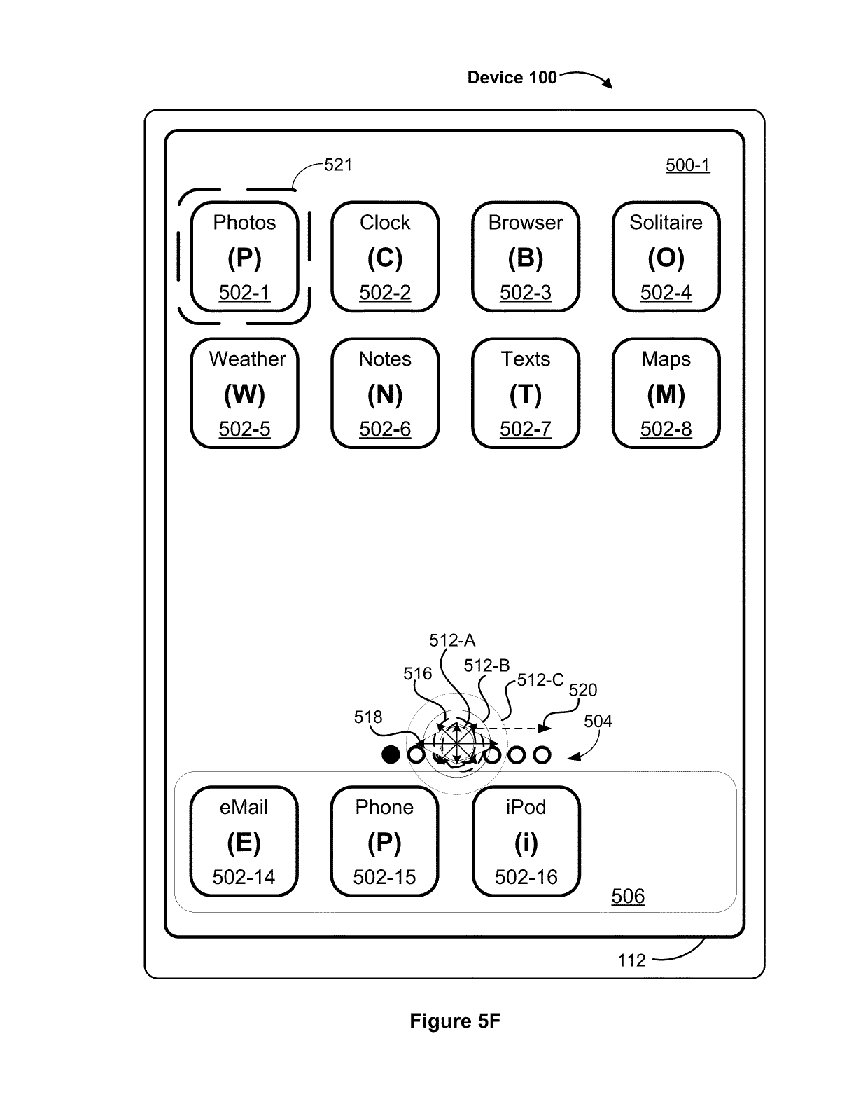

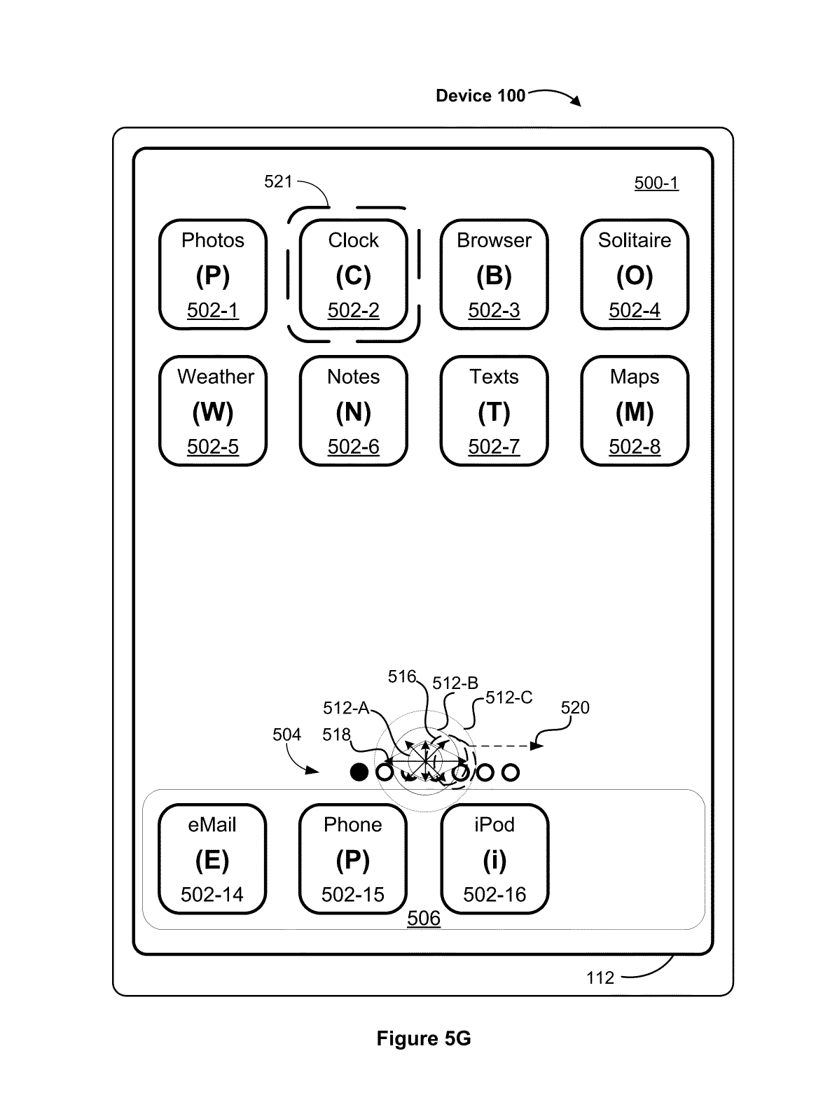

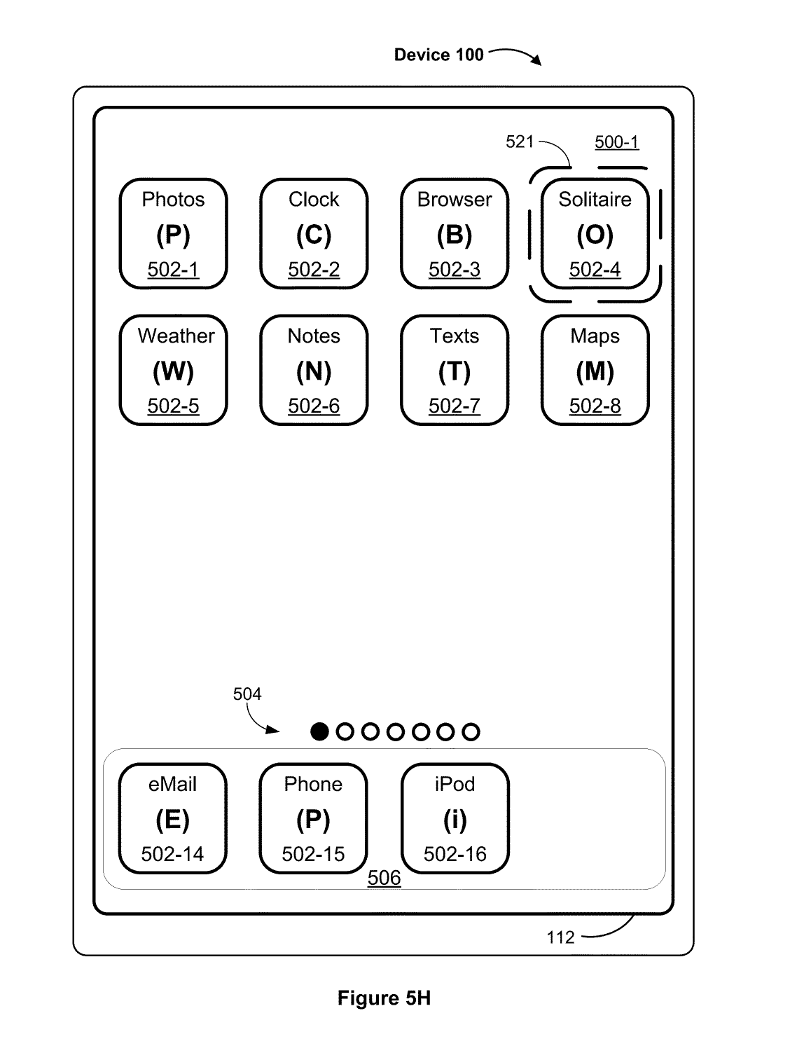

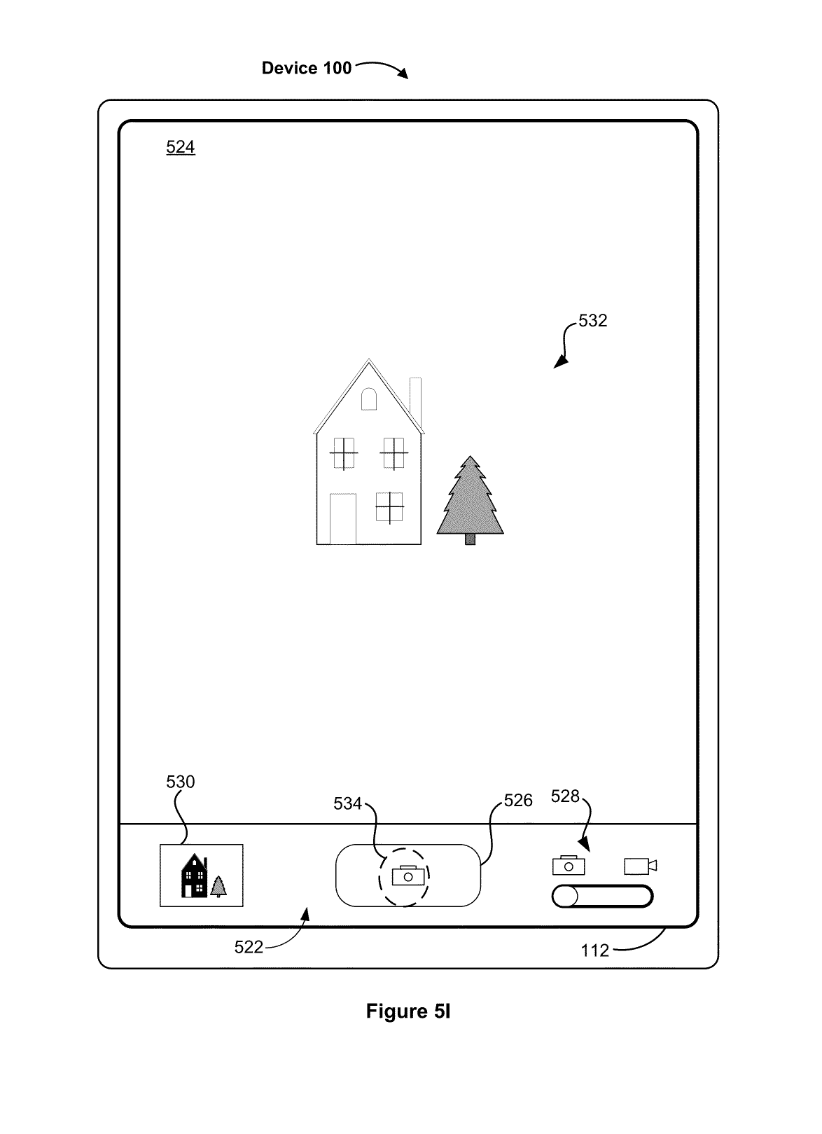

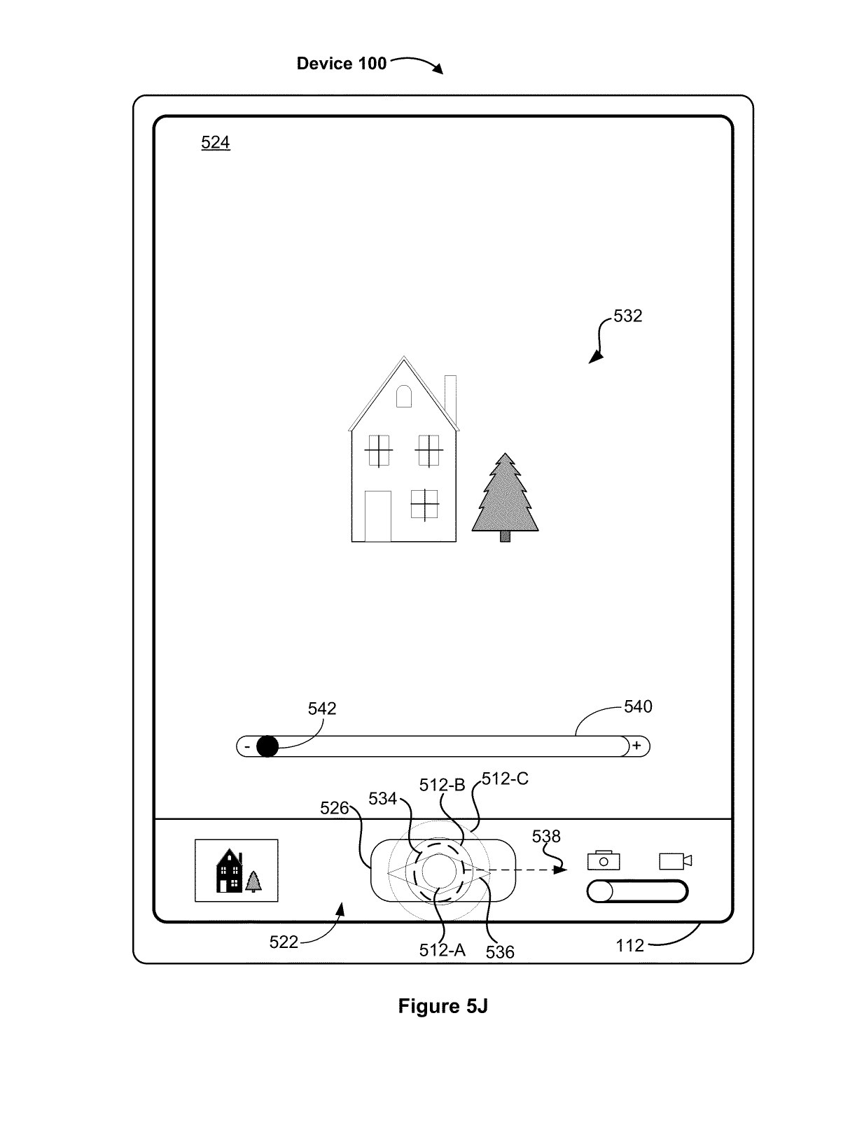

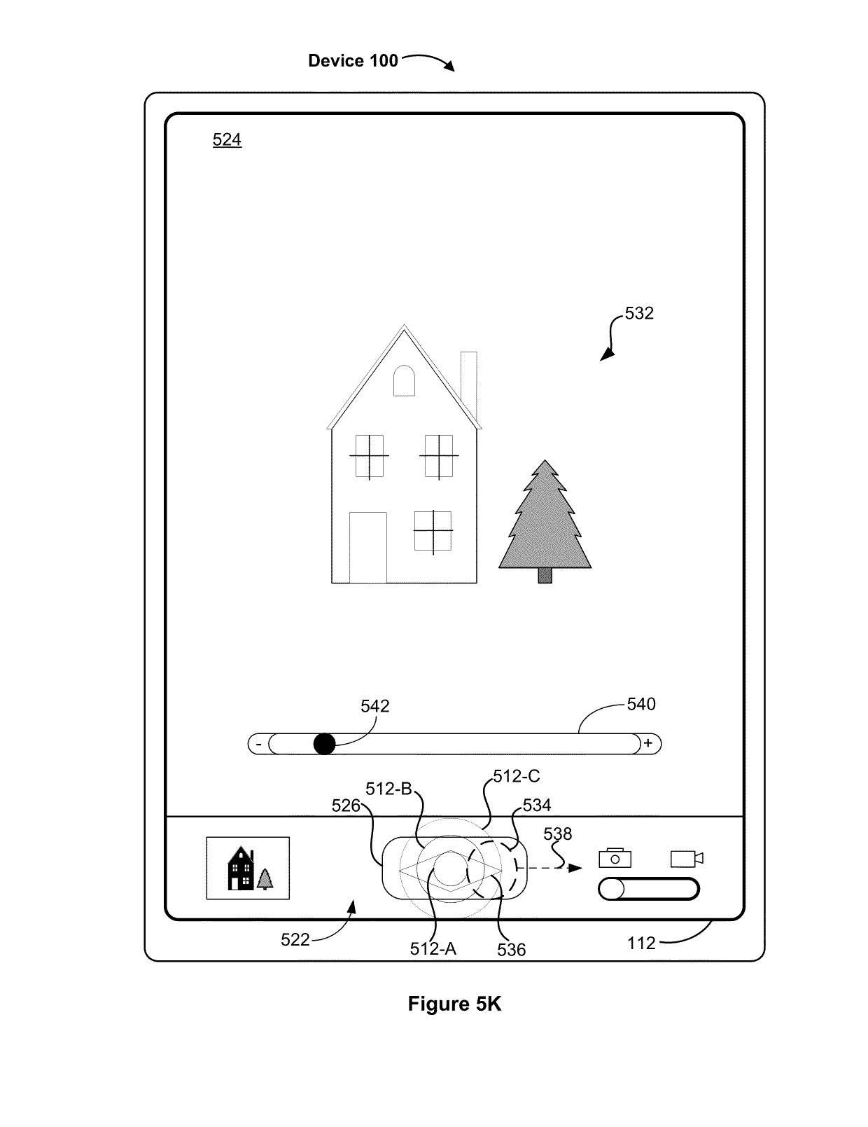

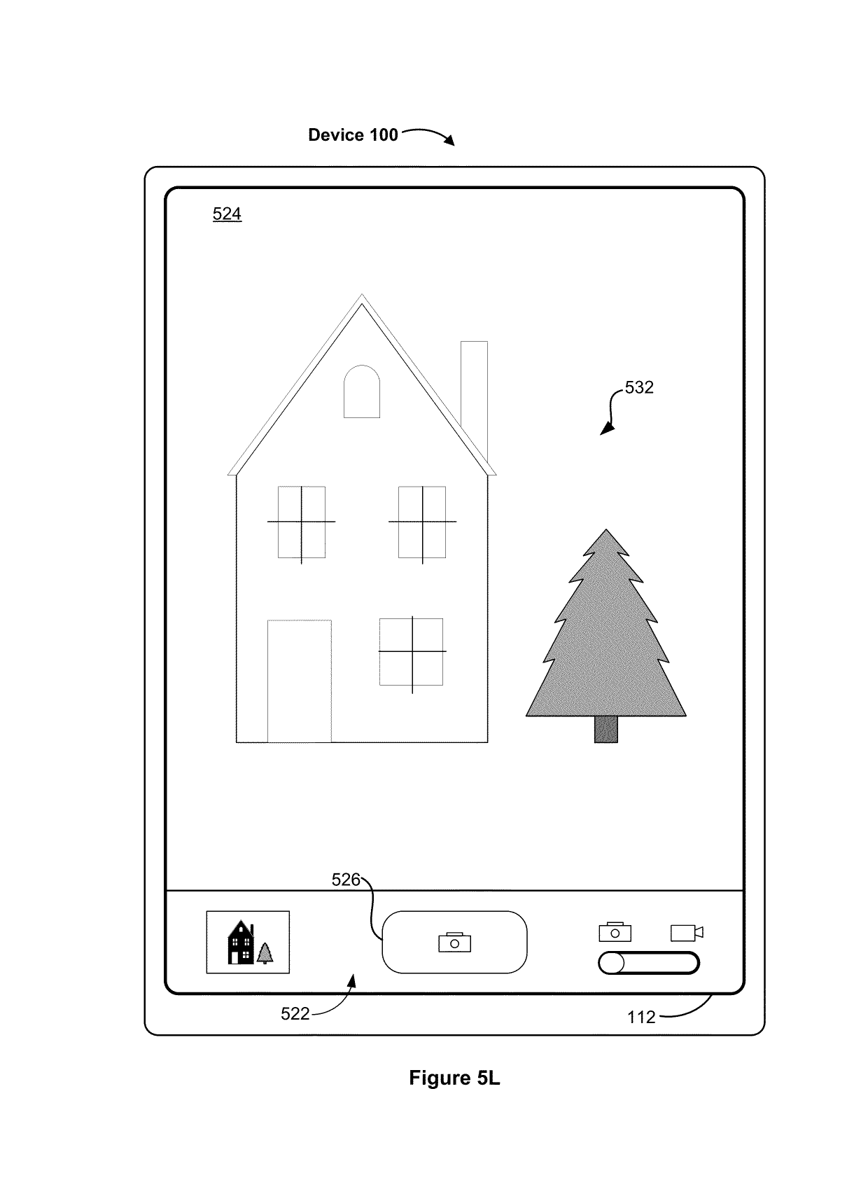

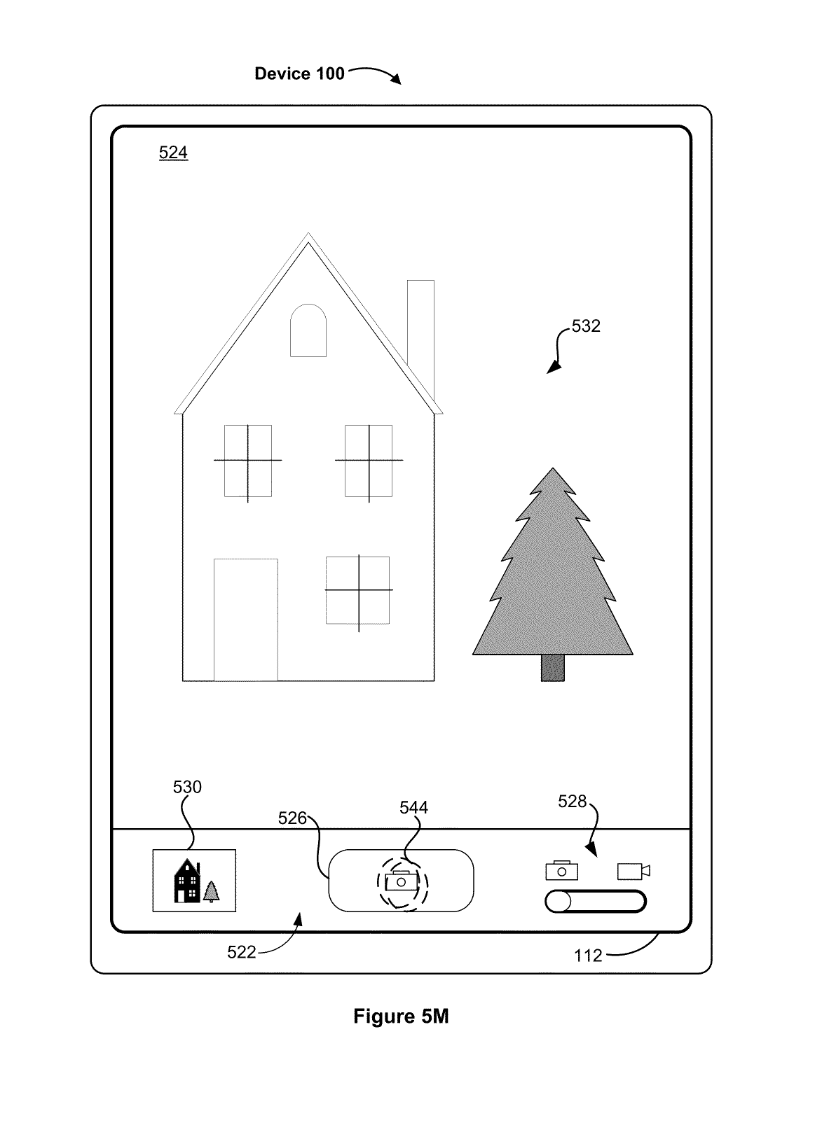

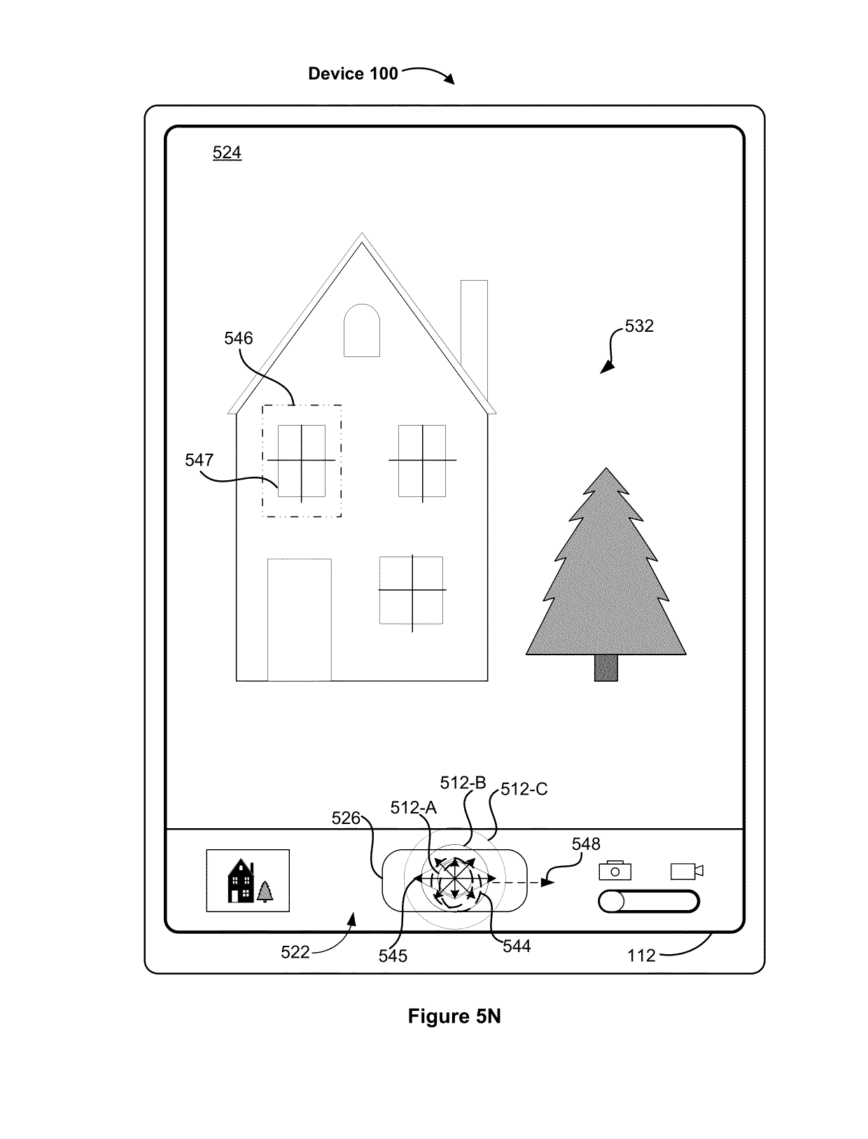

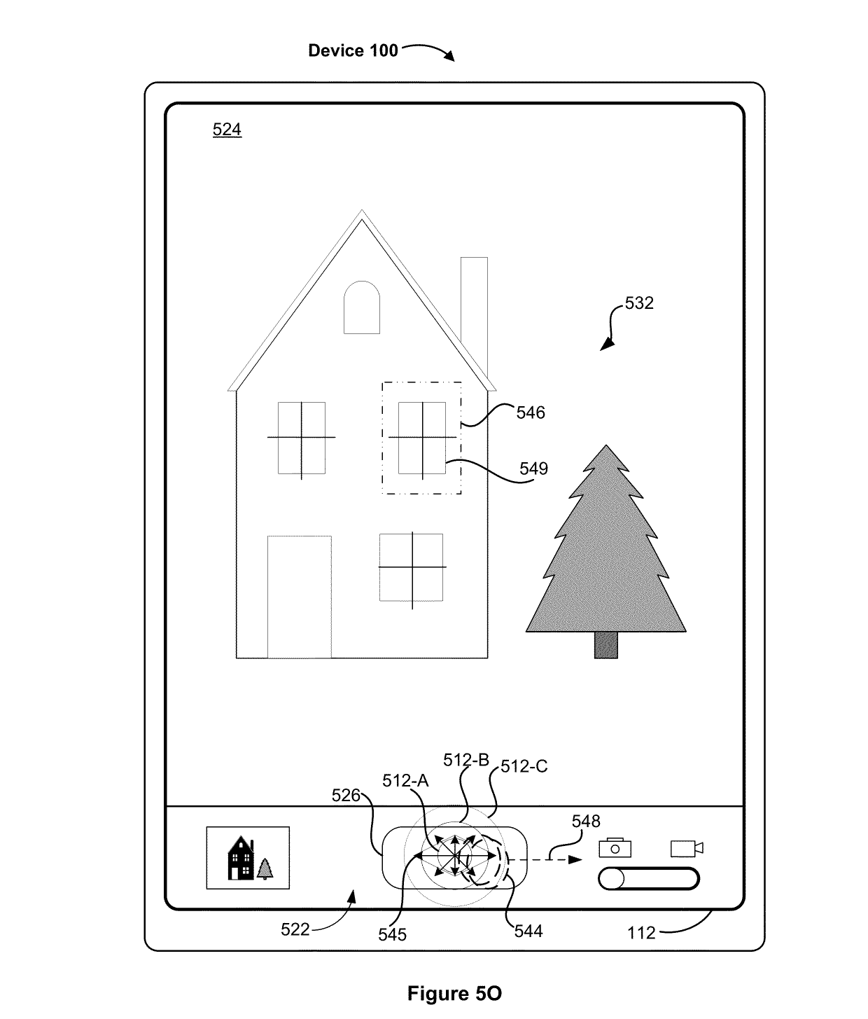

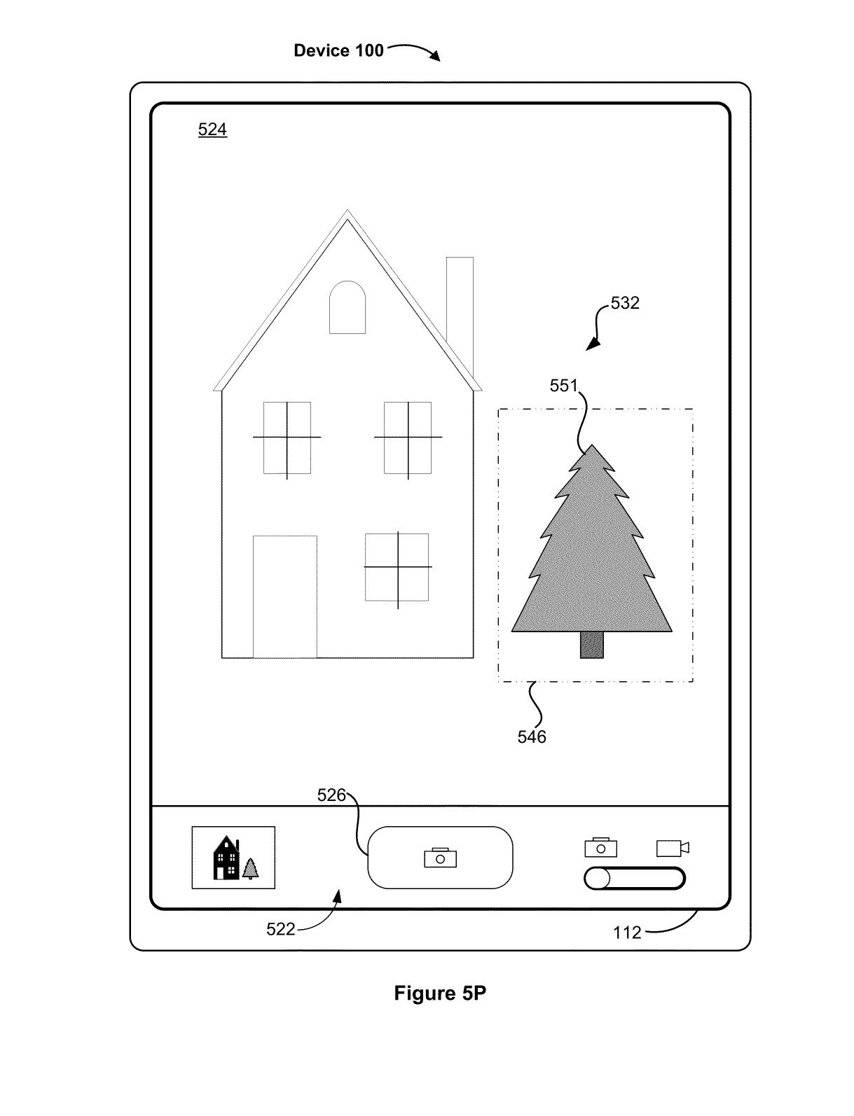

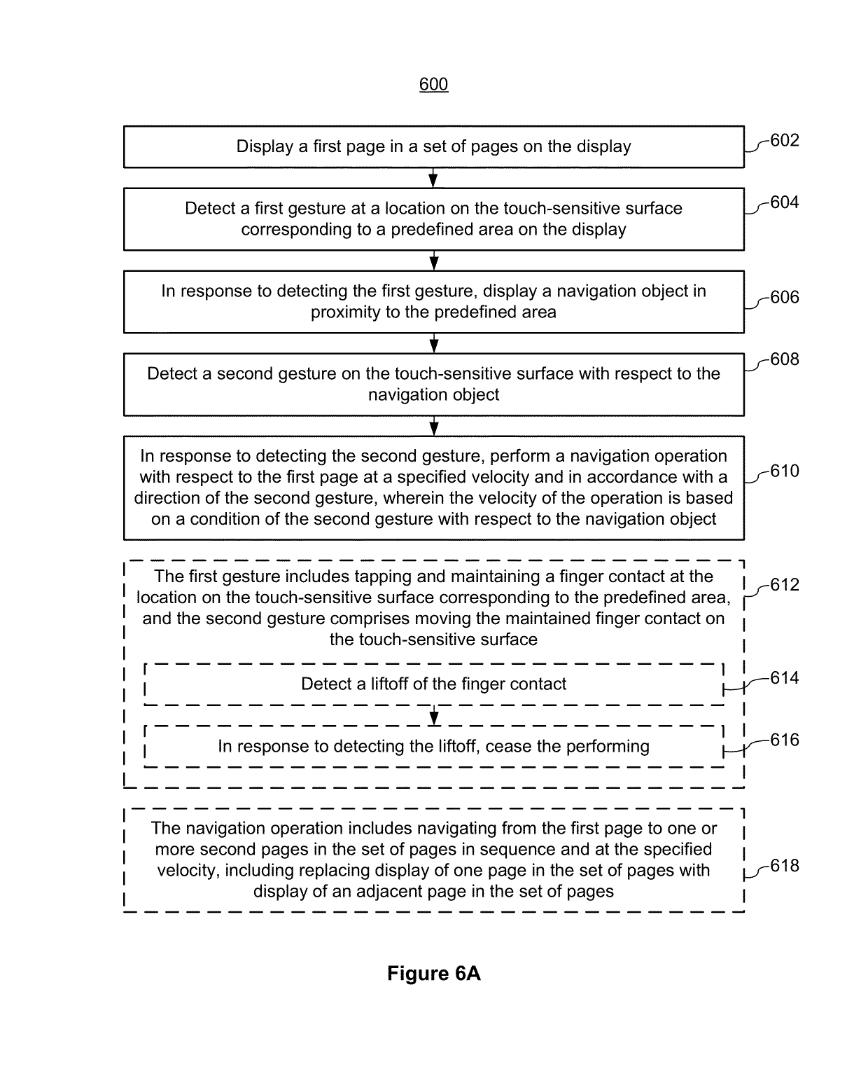

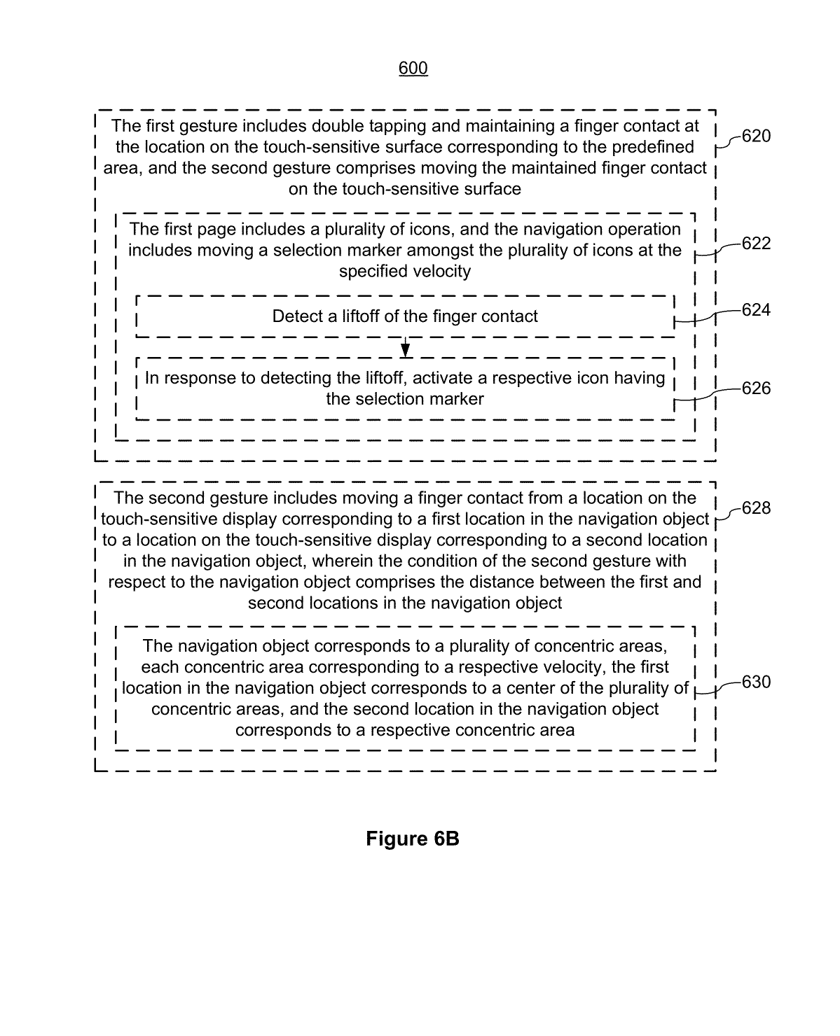

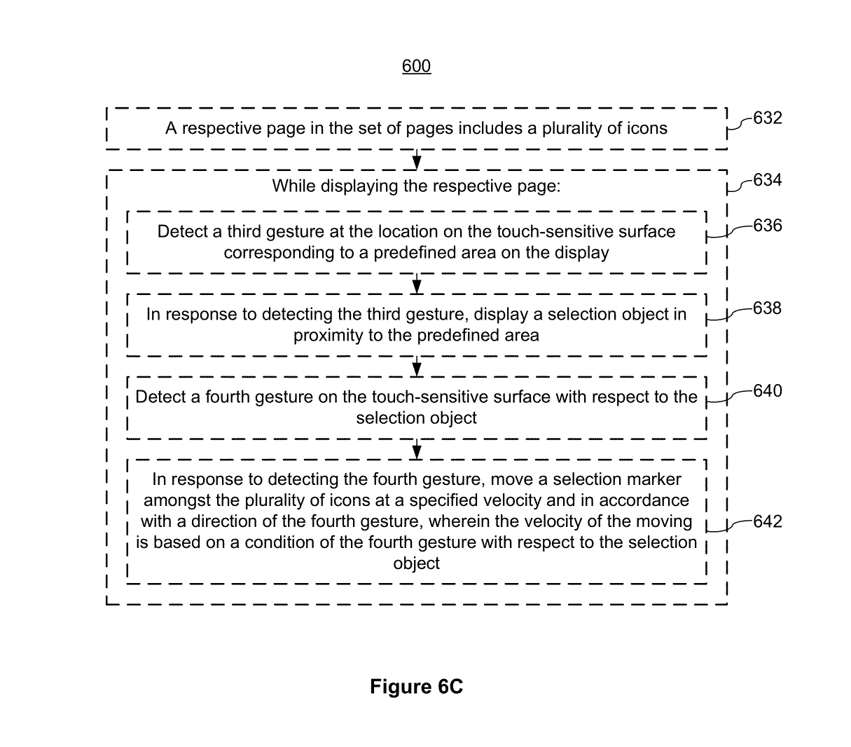

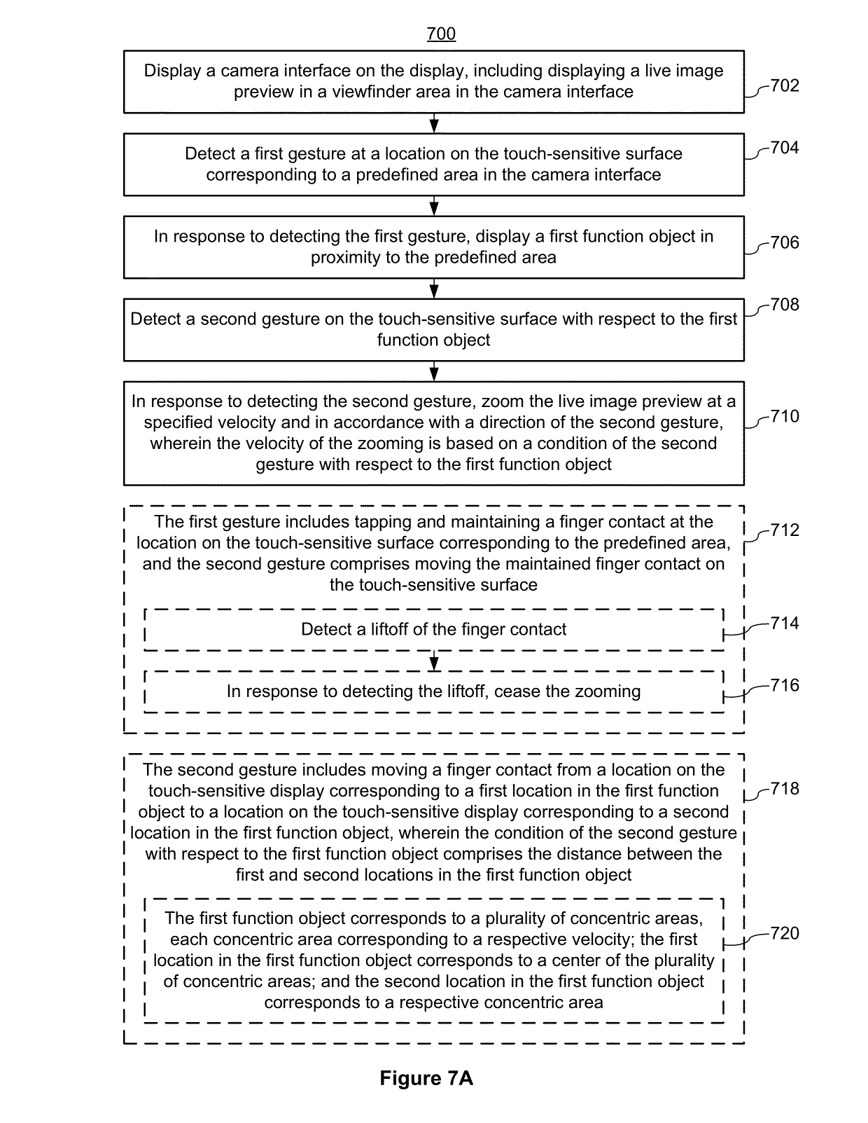

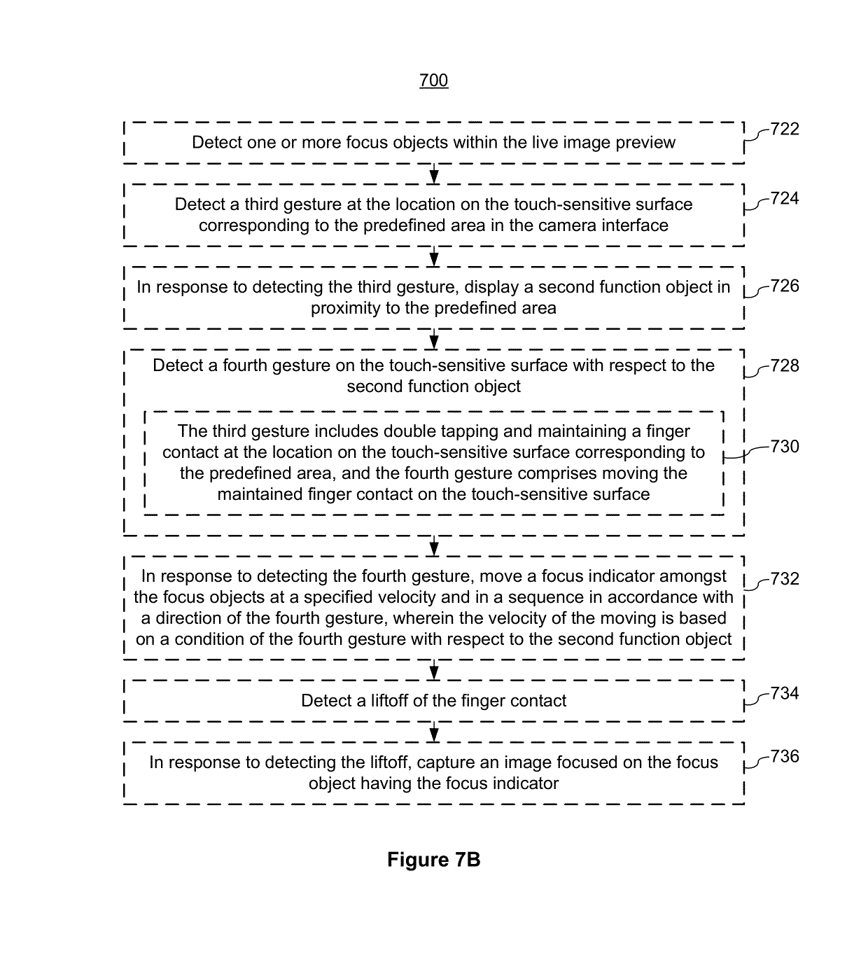

Below, FIGS. 1A-1B, 2, 3, 8-9 provide a description of exemplary devices. FIGS. 4A-4B and 5A-5P illustrate exemplary user interfaces for navigating pages and zooming at variable speeds. FIGS. 6A-6C and 7A-7B are flow diagrams illustrating a method of navigating pages and zooming at variable speeds, respectively. The user interfaces in FIGS. 5A-5P are used to illustrate the processes in FIGS. 6A-6C and 7A-7B.

### Exemplary Devices

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if' may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touch pads), may also be used. It should also be understood that, in some embodiments, the device is not a portable communications device, but is a desktop computer with a touch-sensitive surface (e.g., a touch screen display and/or a touch pad).

In the discussion that follows, an electronic device that includes a display and a touch-sensitive surface is described. It should be understood, however, that the electronic device may include one or more other physical user-interface devices, such as a physical keyboard, a mouse and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive displays 112 in accordance with some embodiments. Touch-sensitive display 112 is sometimes called a “touch screen” for convenience, and may also be known as or called a touch-sensitive display system. Device 100 may include memory 102 (which may include one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 may include one or more optical sensors 164. These components may communicate over one or more communication buses or signal lines 103.

It should be appreciated that device 100 is only one example of a portable multifunction device, and that device 100 may have more or fewer components than shown, may combine two or more components, or may have a different configuration or arrangement of the components. The various components shown in FIG. 1A may be implemented in hardware, software, or a combination of both hardware and software, including one or more signal processing and/or application specific integrated circuits.

Memory 102 may include high-speed random access memory and may also include non-volatile memory, such as one or more magnetic disk storage devices, flash memory devices, or other non-volatile solid-state memory devices. Access to memory 102 by other components of device 100, such as CPU 120 and the peripherals interface 118, may be controlled by memory controller 122.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 may be implemented on a single chip, such as chip 104. In some other embodiments, they may be implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), long term evolution (LTE), near field communication (NFC), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

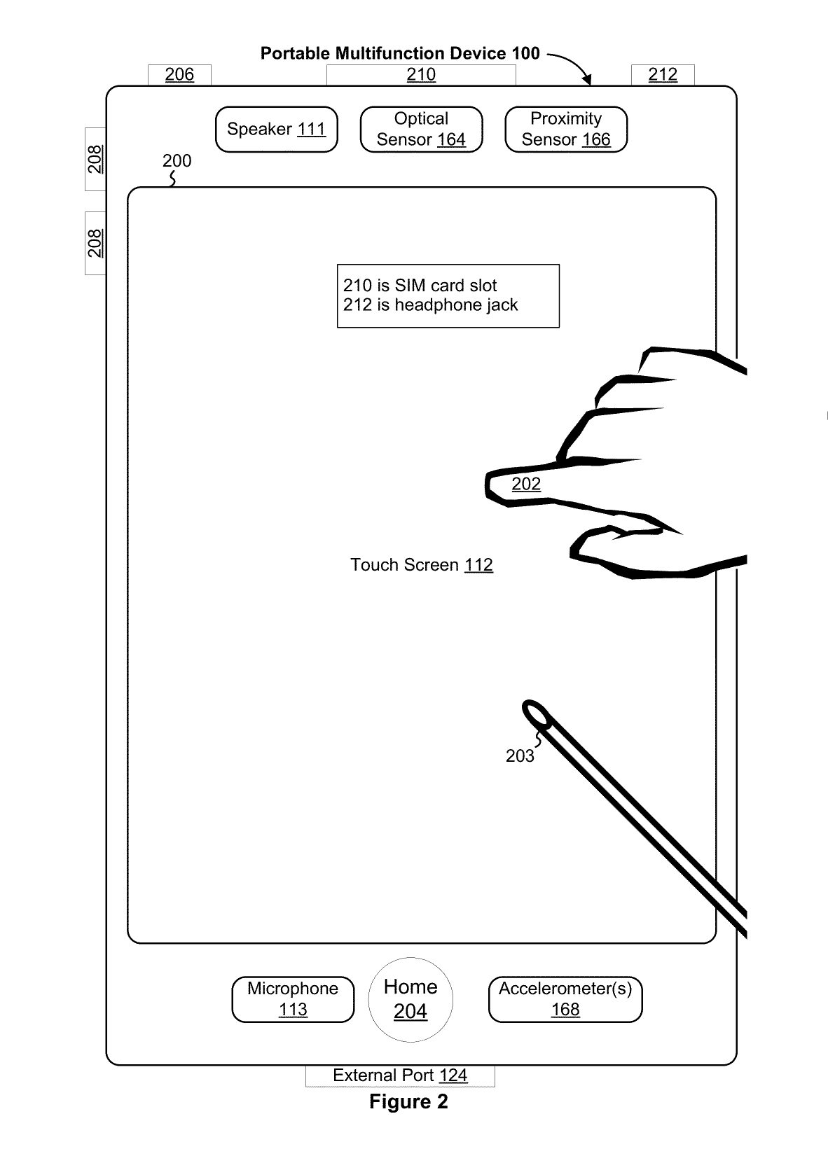

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data may be retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 may include display controller 156 and one or more input controllers 160 for other input or control devices. The one or more input controllers 160 receive/send electrical signals from/to other input or control devices 116. The other input control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of speaker 111 and/or microphone 113. The one or more buttons may include a push button (e.g., 206, FIG. 2).

Touch-sensitive display 112 provides an input interface and an output interface between the device and a user. Display controller 156 receives and/or sends electrical signals from/to touch screen 112. Touch screen 112 displays visual output to the user. The visual output may include graphics, text, icons, video, and any combination thereof (collectively termed “graphics”). In some embodiments, some or all of the visual output may correspond to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and converts the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 may use LCD (liquid crystal display) technology, LPD (light emitting polymer display) technology, or LED (light emitting diode) technology, although other display technologies may be used in other embodiments. Touch screen 112 and display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, Calif.

Touch screen 112 may have a video resolution in excess of 100 dpi. In some embodiments, the touch screen has a video resolution of approximately 160 dpi. The user may make contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from touch screen 112 or an extension of the touch-sensitive surface formed by the touch screen.

Device 100 also includes power system 162 for powering the various components. Power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 may also include one or more optical sensors 164. FIG. 1A shows an optical sensor coupled to optical sensor controller 158 in I/O subsystem 106. Optical sensor 164 may include charge-coupled device (CCD) or complementary metal-oxide semiconductor (CMOS) phototransistors. Optical sensor 164 receives light from the environment, projected through one or more lens, and converts the light to data representing an image. In conjunction with imaging module 143 (also called a camera module), optical sensor 164 may capture still images or video. In some embodiments, an optical sensor is located on the back of device 100, opposite touch screen display 112 on the front of the device, so that the touch screen display may be used as a viewfinder for still and/or video image acquisition. In some embodiments, another optical sensor is located on the front of the device so that the user's image may be obtained for videoconferencing while the user views the other video conference participants on the touch screen display.

Device 100 may also include one or more proximity sensors 166. FIG. 1A shows proximity sensor 166 coupled to peripherals interface 118. Alternately, proximity sensor 166 may be coupled to input controller 160 in I/O subsystem 106. In some embodiments, the proximity sensor turns off and disables touch screen 112 when the multifunction device is placed near the user's ear (e.g., when the user is making a phone call).

Device 100 may also include one or more accelerometers 168. FIG. 1A shows accelerometer 168 coupled to peripherals interface 118. Alternately, accelerometer 168 may be coupled to an input controller 160 in I/O subsystem 106. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

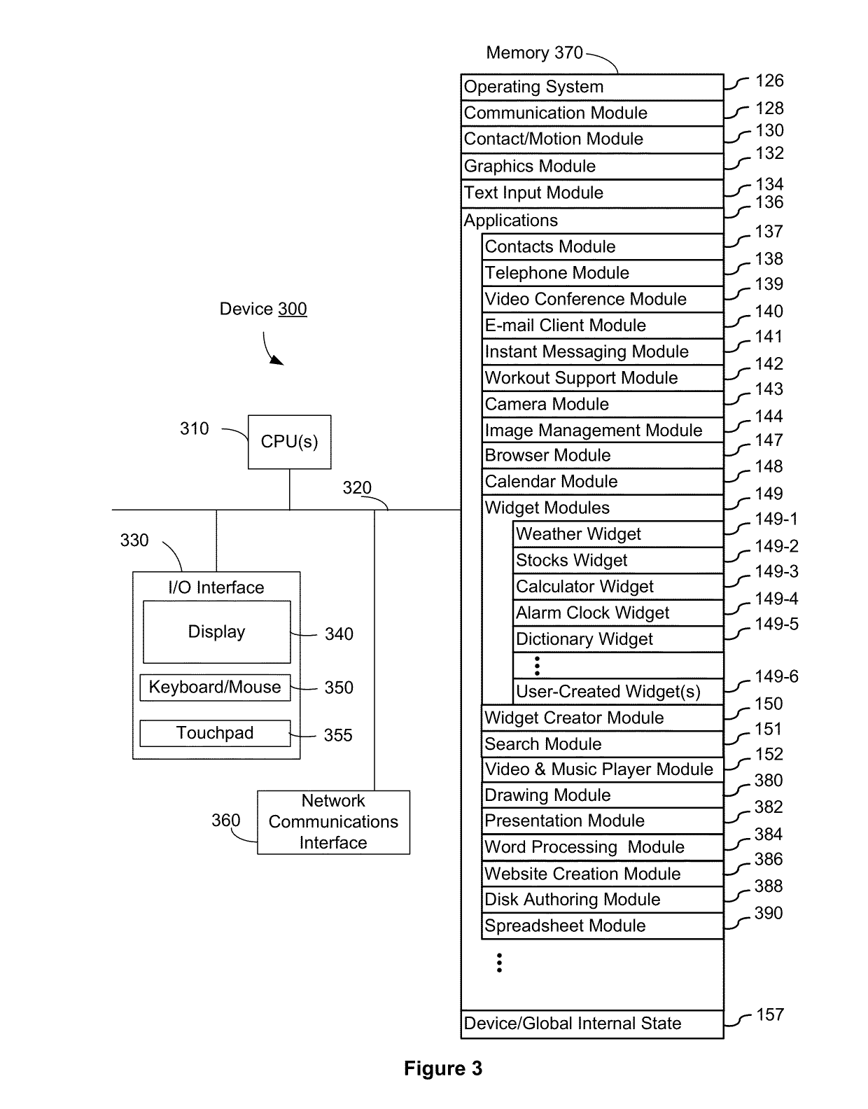

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 may detect contact with touch screen 112 (in conjunction with display controller 156) and other touch sensitive devices (e.g., a touchpad or physical click wheel). Contact/motion module 130 includes various software components for performing various operations related to detection of contact, such as determining if contact has occurred (e.g., detecting a finger-down event), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, contact/motion module 130 and display controller 156 detect contact on a touchpad.

Contact/motion module 130 may detect a gesture input by a user. Different gestures on the touch-sensitive surface have different contact patterns. Thus, a gesture may be detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event.

Graphics module 132 includes various known software components for rendering and displaying graphics on touch screen 112 or other display, including components for changing the intensity of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic may be assigned a corresponding code. Graphics module 132 receives, from applications etc., one or more codes specifying graphics to be displayed along with, if necessary, coordinate data and other graphic property data, and then generates screen image data to output to display controller 156.

Text input module 134, which may be a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 may include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which may include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which may be made up of a video player module and a music player module;
notes module 153;
map module 154; and/or
online video module 155.

Examples of other applications 136 that may be stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact module 130, graphics module 132, and text input module 134, contacts module 137 may be used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, telephone module 138 may be used to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch screen 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages. In some embodiments, transmitted and/or received instant messages may include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact module 130, graphics module 132, text input module 134, GPS module 135, map module 154, and music player module 146, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store and transmit workout data.

In conjunction with touch screen 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display system controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch screen 112, display system controller 156, contact module 130, graphics module 132, text input module 134, and browser module 147, widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display system controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch screen 112 or on an external, connected display via external port 124). In some embodiments, device 100 may include the functionality of an MP3 player, such as an iPod (trademark of Apple Inc.).

In conjunction with touch screen 112, display controller 156, contact module 130, graphics module 132, and text input module 134, notes module 153 includes executable instructions to create and manage notes, to do lists, and the like in accordance with user instructions.

In conjunction with RF circuitry 108, touch screen 112, display system controller 156, contact module 130, graphics module 132, text input module 134, GPS module 135, and browser module 147, map module 154 may be used to receive, display, modify, and store maps and data associated with maps (e.g., driving directions; data on stores and other points of interest at or near a particular location; and other location-based data) in accordance with user instructions.

In conjunction with touch screen 112, display system controller 156, contact module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 may be reduced.

The predefined set of functions that may be performed exclusively through a touch screen and/or a touchpad include navigation between user interfaces. In some embodiments, the touchpad, when touched by the user, navigates device 100 to a main, home, or root menu from any user interface that may be displayed on device 100. In such embodiments, the touchpad may be referred to as a “menu button.” In some other embodiments, the menu button may be a physical push button or other physical input control device instead of a touchpad.

FIG. 1B is a block diagram illustrating exemplary components for event handling in accordance with some embodiments. In some embodiments, memory 102 (in FIGS. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected may correspond to programmatic levels within a programmatic or view hierarchy of the application. For example, the lowest level view in which a touch is detected may be called the hit view, and the set of events that are recognized as proper inputs may be determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (i.e., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 may utilize or call data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which may include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch the event information may also include speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers may interact with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module 145. In some embodiments, object updater 177 creates and updates objects used in application 136-1. For example, object updater 176 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens, e.g., coordinating mouse movement and mouse button presses with or without single or multiple keyboard presses or holds, user movements taps, drags, scrolls, etc., on touch-pads, pen stylus inputs, movement of the device, oral instructions, detected eye movements, biometric inputs, and/or any combination thereof, which may be utilized as inputs corresponding to sub-events which define an event to be recognized.

FIG. 2 illustrates a portable multifunction device 100 having a touch screen 112 in accordance with some embodiments. The touch screen may display one or more graphics within user interface (UI) 200. In this embodiment, as well as others described below, a user may select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture may include one or more taps, one or more swipes (from left to right, right to left, upward and/or downward) and/or a rolling of a finger (from right to left, left to right, upward and/or downward) that has made contact with device 100. In some embodiments, inadvertent contact with a graphic may not select the graphic. For example, a swipe gesture that sweeps over an application icon may not select the corresponding application when the gesture corresponding to selection is a tap.

Device 100 may also include one or more physical buttons, such as “home” or menu button 204. As described previously, menu button 204 may be used to navigate to any application 136 in a set of applications that may be executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also may accept verbal input for activation or deactivation of some functions through microphone 113.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 may include circuitry (sometimes called a chipset) that interconnects and controls communications between system components. Device 300 includes input/output (I/O) interface 330 comprising display 340, which is typically a touch screen display. I/O interface 330 also may include a keyboard and/or mouse (or other pointing device) 350 and touchpad 355. Memory 370 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 370 may optionally include one or more storage devices remotely located from CPU(s) 310. In some embodiments, memory 370 stores programs, modules, and data structures analogous to the programs, modules, and data structures stored in memory 102 of portable multifunction device 100 (FIG. 1), or a subset thereof. Furthermore, memory 370 may store additional programs, modules, and data structures not present in memory 102 of portable multifunction device 100. For example, memory 370 of device 300 may store drawing module 380, presentation module 382, word processing module 384, website creation module 386, disk authoring module 388, and/or spreadsheet module 390, while memory 102 of portable multifunction device 100 (FIG. 1) may not store these modules.

Each of the above identified elements in FIG. 3 may be stored in one or more of the previously mentioned memory devices. Each of the above identified modules corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 370 may store a subset of the modules and data structures identified above. Furthermore, memory 370 may store additional modules and data structures not described above.

Attention is now directed towards embodiments of user interfaces (“UI”) that may be implemented on portable multifunction device 100.

FIG. 4A illustrates an exemplary user interface for a menu of applications on portable multifunction device 100 in accordance with some embodiments. Similar user interfaces may be implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Phone 138, which may include an indicator 414 of the number of missed calls or voicemail messages;
E-mail client 140, which may include an indicator 410 of the number of unread e-mails;
   Browser 147; and
   Video and music player 152, also referred to as iPod (trademark of Apple Inc.) module 152; and
      Icons for other applications, such as:
   IM 141;
   Image management 144;
   Camera 143;
   Weather 149-1;
   Stocks 149-2;
   Workout support 142;
   Calendar 148;
   Alarm clock 149-4;
   Map 154;
   Notes 153;
   Settings 412, which provides access to settings for device 100 and its various applications 136; and
   Online video module 155, also referred to as YouTube (trademark of Google Inc.) module 155.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Although many of the examples which follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments the touch sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods may be used for other user interfaces described herein.

### User Interfaces and Associated Processes

Attention is now directed towards embodiments of user interfaces (“UI”) and associated processes that may be implemented on an electronic device with a display and a touch-sensitive surface, such as device 300 or portable multifunction device 100.

FIGS. 5A-5P illustrate exemplary user interfaces for navigating and zooming at variable speeds in accordance with some embodiments. The user interfaces in these figures are used to illustrate the processes described below, including the processes in FIGS. 6A-6C and 7A-7B.

FIG. 5A illustrates page 500-1 displayed on touch-sensitive display 112 of device 100. Page 500-1 includes a user interface analogous to user interface 400 (FIG. 4A). Page 500-1 includes application icons 502. Each application icon 502 corresponds to a respective application. An application icon 502 may be activated (e.g., in response to the detection of a gesture, such as a tap gesture, on the respective icon). In response to the activation of an application icon 502, device 100 activates the corresponding application. In some implementations, one or more of icons 502 correspond to respective application icons illustrated in FIG. 4A.

In FIG. 5A, page 500-1 is one of multiple pages 500 that have user interfaces with application icons 502. Page indicator 504 may be displayed concurrently with page 500-1 to indicate the number of pages 500 and the position of the currently displayed page relative to the other pages in the sequence of pages.

Tray 506 may be displayed concurrently with page 500-1. Tray 506 may include one or more frequently-used application icons 502. Tray 506 corresponds with tray 408 in FIG. 4A. In some embodiments, tray 506 is persistent across multiple pages (e.g., as shown in FIGS. 5B-5D).

Gesture 508 is detected on a location on touch-sensitive display 112 corresponding to page indicator 504. In some embodiments, gesture 508 is a tap and hold gesture (i.e., a finger contact is tapped onto touch-sensitive display 112 and maintained). For convenience, the maintained finger contact in gesture 508 will be referred to as finger contact 508 in the Figures. In response to the detection of gesture 508, navigation object 510 is displayed, as shown in FIG. 5B. In some embodiments, navigation object 510 is centered on gesture 508 and is displayed in proximity to page indicator 504.

Navigation object 510 is associated with three concentric areas 512 that may be hidden (i.e., not displayed on display 112). The three concentric areas are centered on navigation object 510. Each concentric area 512 corresponds to a respective relative speed. The center-most area 512-A corresponds to a slow speed. The next area 512-B corresponds to a medium speed. The outermost area 512-C corresponds to a fast speed.

Movement 514 of gesture 508 is detected. In response to the detection of movement 514, device 100 navigates from page 500-1 to other pages 500 in accordance with the direction of movement 514. In some embodiments, the pages 500 move in the same direction as movement 514. Conversely, in some embodiments, the pages 500 move in a direction opposite movement 514 (not shown). The navigation continues as long as contact 508 is maintained. For example, in FIG. 5C, display of page 500-2 has replaced display of page 500-1. In some embodiments, an animation showing page 500-1 moving leftward (same direction as movement 514) and out of view, replaced by page 500-2 moving into view, is displayed. Page indicator 504 is changed to indicate that the second page in the sequence of pages 500 is the current page (page 500-2, FIG. 5C).

As gesture 508 moves, finger contact 508 is positioned in one of the concentric areas 512. The speed of the navigation through pages 500 varies with the position of contact 508 with respect to the concentric areas 512. If contact 508 is positioned in area 512-A, the navigation is relatively slow. In some embodiments, the slow navigation is 1-2 pages per second. If contact 508 is positioned in area 512-B, the navigation is at a “medium” speed. In some embodiments, the medium speed navigation is 2-4 pages per second. If the contact is positioned in area 512-C, the navigation is at a “fast” speed. In some embodiments, the fast speed navigation is 4-8 pages per second. In some embodiments, the position of contact 508 is determined based on the centroid of contact 508.

In FIG. 5C, contact 508 is positioned in area 512-B. In response, the navigation is faster. For example, device 100 navigates from page 500-2 to page 500-3 (the sixth page in the sequence of pages 500) at the medium speed, as shown in FIG. 5D. With the ceasing of gesture 508 (e.g., liftoff of contact 508), the navigation stops and navigation object 510 ceases to be displayed.

In some embodiments, if contact 508, after some movement, stops moving but is not lifted off, then device 100 navigates amongst pages 500 at a speed based on the position of contact 508 with respect to concentric areas 512.

FIG. 5E shows page 500-1 with page indicator 504 and tray 506. Gesture 516 is detected on a location on touch-sensitive display 112 corresponding to page indicator 504. In some embodiments, gesture 516 is a double tap and hold gesture (i.e., a tap on touch-sensitive display 112 with liftoff, and then a finger contact is tapped onto touch-sensitive display 112 and maintained). For convenience, the maintained finger contact in gesture 516 is referred to as finger contact 516 in the Figures. In response to the detection of gesture 516, selection object 518 and selection marker 521 are displayed, as shown in FIG. 5F. Selection marker 521 is displayed around icon 502-1. In some embodiments, selection object 518 is centered on gesture 516 and is displayed in proximity to page indicator 504.

Selection object 518, as with navigation object 510, is also associated with three concentric areas 512 that may be hidden. The three concentric areas are centered on selection object 518. Each concentric area 512 corresponds to a respective relative speed. The center-most area 512-A corresponds to a slow speed. The next area 512-B corresponds to a medium speed. The outermost area 512-C corresponds to a fast speed.

Movement 520 of gesture 516 is detected. In response to the detection of movement 520, device 100 moves selection marker 521 on the current page (in FIG. 5F, page 500-1) in accordance with the direction of movement 520. In some embodiments, the selection marker 510 moves in the same direction as movement 520. Conversely, in some embodiments, the selection marker 510 moves in a direction opposite movement 520 (not shown). The movement of selection marker 521 continues as long as contact 516 is maintained. For example, in FIG. 5G, selection marker 521 is moved to be around icon 502-2.

As gesture 516 moves, finger contact 516 is positioned in one of the concentric areas 512. The speed of the movement of selection marker 521 through icons 502 varies with the position of contact 516 with respect to the concentric areas 512. If contact 516 is positioned in area 512-A, the movement is relatively slow. In some embodiments, the slow movement is 1-2 icons per second. If contact 516 is positioned in area 512-B, the movement is at a “medium” speed. In some embodiments, the medium speed movement is 2-4 icons per second. If contact 516 is positioned in area 512-C, the movement is at a “fast” speed. In some embodiments, the fast speed movement is 4-8 icons per second. In some embodiments, the position of the contact is determined based on the centroid of the maintained contact 516.

In FIG. 5G, contact 516 is positioned in area 512-B. In response, the movement of selection marker 521 is faster. For example, selection marker 521 is moved from icon 502-2 to icon 502-4 at the medium speed, as shown in FIG. 5H. When gesture 516 ceases (e.g., liftoff of contact 516), the movement of selection marker 521 stops and whichever icon 502 that selection marker 521 surrounds is activated. Thus, in FIG. 5H, icon 502-4 is activated.

In some embodiments, if contact 516, after some movement, stops moving but is not lifted off, then device 100 moves selection marker 521 at a speed based on the position of contact 516 with respect to concentric areas 512.

FIG. 5I illustrates camera interface 522 displayed on touch-sensitive display 112 of device 100. Camera interface 522 includes live preview (or “viewfinder”) area 524, where live image preview 532 is displayed, and shutter button 526. In some embodiments, other user interface objects, such as still image—video toggle switch 528 and camera roll icon 530, are included in camera interface 522.

Gesture 534 is detected on a location on touch-sensitive display 112 corresponding to shutter button 526. In some embodiments, gesture 534 is a tap and hold gesture (i.e., a finger contact is tapped onto touch-sensitive display 112 and maintained). For convenience, the maintained finger contact in gesture 534 is referred to as finger contact 534 in the Figures. In response to the detection of gesture 534, function object 536 and zoom level bar 540, with zoom level indicator 542, are displayed, as shown in FIG. 5J. In some embodiments, function object 536 is centered on gesture 534 and is displayed in proximity to shutter button 526.

Function object 536 is associated with three concentric areas 512 that may be hidden. The three concentric areas are centered on function object 536. Each concentric area 512 corresponds to a respective relative speed. The center-most area 512-A corresponds to a slow speed. The next area 512-B corresponds to a medium speed. The outermost area 512-C corresponds to a fast speed.

Movement 538 of gesture 534 is detected. In response to the detection of movement 534, live image preview 532 is zoomed (in or out) to a different level in accordance with the direction of movement 538. The zooming continues as long as contact 534 is maintained. For example, in FIG. 5K, live image preview 532 is zoomed to a larger size, as indicated by a different position of zoom level indicator 542 along zoom level bar 540.

As gesture 534 moves, finger contact 534 is positioned in one of the concentric areas 512. The speed of the zooming varies with the position of contact 534 of gesture 534 with respect to the concentric areas 512. If contact 534 is positioned in area 512-A, the zooming is relatively slow. If contact 534 is positioned in area 512-B, the zooming is at a “medium” speed. If contact 534 is positioned in area 512-C, the zooming is at a “fast” speed. In some embodiments, the position of contact 534 is determined based on the centroid of the maintained contact 534.

In FIG. 5K, contact 534 is positioned in area 512-C. In response, the zooming is faster. For example, live image preview 532 is zoomed to a larger level at the fast speed, as shown in FIG. 5L. With the ceasing of gesture 534 (e.g., liftoff of contact 534), the zooming stops and function object 536 ceases to be displayed.

In some embodiments, if contact 534, after some movement, stops moving but is not lifted off, then live image preview 532 is zoomed in or out (in accordance with the direction of the stopped movement) at a speed based on the position of contact 534 with respect to concentric areas 512.

FIG. 5M illustrates camera interface 522 displayed on touch-sensitive display 112 of device 100. Camera interface 522 includes live preview (or “viewfinder”) area 524, where live image preview 532 is displayed, and shutter button 526. The live image preview 532 may be generated from data sensed by optical sensors in a camera on device 100 (e.g., optical sensors 164). In some embodiments, other user interface objects, such as still image—video toggle switch 528 and camera roll icon 530, are included in camera interface 522.

Gesture 544 is detected on a location on touch-sensitive display 112 corresponding to shutter button 526. In some embodiments, gesture 544 is a double tap and hold gesture (i.e., a tap on touch-sensitive display 112 with liftoff, and then a finger contact is tapped onto touch-sensitive display 112 and maintained). For convenience, the maintained finger contact in gesture 544 is referred to as finger contact 544 in the Figures. In response to the detection of gesture 544, function object 545 and focus object marker 546 are displayed, as shown in FIG. 5N. In some embodiments, function object 545 is centered on gesture 544 and is displayed in proximity to shutter button 526. Device 100 detects one or more focus objects in live image preview 532. In some embodiments, a focus object is a feature in live image preview 532 that the camera of device 100 focuses upon when capturing the image previewed by live image preview 532. For example, in FIG. 5N, the focus object indicated by focus object marker is window 547 that is on the house in live image preview 532. Other focus objects in live image preview 532 may include, for example, other windows on the house, the door of the house, the entire house, and the tree to the right of the house.

Function object 545 is associated with three concentric areas 512 that may be hidden. The three concentric areas are centered on function object 545. Each concentric area 512 corresponds to a respective relative speed. The center-most area 512-A corresponds to a slow speed. The next area 512-B corresponds to a medium speed. The outermost area 512-C corresponds to a fast speed.

Movement 548 of gesture 544 is detected. In response to the detection of movement 544, focus object marker 546 is moved amongst the detected focus objects in a sequence in accordance with the direction of movement 548. The movement of focus object marker 546 continues as long as contact 544 is maintained. For example, in FIG. 5O, focus object marker 546 is moved to window 549 in live image preview 532.

As gesture 544 moves, finger contact 544 is positioned in one of the concentric areas 512. The speed of the movement of focus object marker 546 varies with the position of contact 544 with respect to the concentric areas 512. If contact 544 is positioned in area 512-A, the movement is relatively slow. If contact 544 is positioned in area 512-B, the movement is at a “medium” speed. If contact 544 is positioned in area 512-C, the movement is at a “fast” speed. In some embodiments, the position of contact 544 is determined based on the centroid of contact 544.

In FIG. 5O, contact 544 is positioned in area 512-C. In response, the movement of focus object marker 546 is faster. For example, focus image marker 546 is moved to a different object at the fast speed, as shown in FIG. 5P. With the ceasing of gesture 544 (e.g., liftoff of finger contact 544), the movement of focus object marker 546 stops at a focus object (in FIG. 5P, at tree 551) and function object 536 ceases to be displayed. An image, as previewed by live image preview 532, is captured, with the focus in the captured image on tree 551 indicated by focus object marker 546.

In some embodiments, if contact 544, after some movement, stops moving but is not lifted off, then focus object marker 546 moves from object to object at a speed based on the position of contact 544 with respect to concentric areas 512.

FIGS. 6A-6C are flow diagrams illustrating a method 600 of navigating through pages at variable speeds in accordance with some embodiments. The method 600 is performed at an electronic device (e.g., device 300, FIG. 3, or portable multifunction device 100, FIG. 1) with a display and a touch-sensitive surface. In some embodiments, the display is a touch screen display and the touch-sensitive surface is on the display. In some embodiments, the display is separate from the touch-sensitive surface. Some operations in method 600 may be combined and/or the order of some operations may be changed.

As described below, the method 600 provides an intuitive way to navigate through pages at variable speeds. The method enables a user to find a desired page faster, thereby creating a more efficient human-machine interface. For battery-operated electronic devices, enabling a user to navigate through pages faster and more efficiently conserves power and increases the time between battery charges.

The device displays (602) a first page in a set of pages on the display. In some embodiments, the set of pages include pages of icons (e.g., application icons), such as the user interface with application icons shown in FIG. 4A (where the user interface shown is one page in a set of pages with application icons). For example, in FIG. 5A and 5E, page 500-1 of application icons is displayed. Page 500-1 is one of multiple pages of application icons, as indicated by page indicator 504.

The device detects (604) a first gesture at a location on the touch-sensitive surface corresponding to a predefined area on the display. In some embodiments, the first gesture includes tapping on touch screen 112 with a finger contact at a location corresponding to the predefined area and maintaining the finger contact on touch screen 112. For example, in FIG. 5A the first gesture, which includes finger contact 508 tapping and holding on touch screen 112, is detected on touch screen 112 at a location corresponding to page indicator 504, where page indicator 504 is the predefined area. As another example, in FIG. 5E the first gesture, which includes finger contact 516 double-tapping and holding on touch screen 112, is detected on touch screen 112 at a location corresponding to page indicator 504.

In response to detecting the first gesture, the device displays (606) a navigation object in proximity to the predefined area. For example, in FIG. 5B, navigation object 510 is displayed over a portion of page indicator 504. Navigation object 510 may serve as a visual cue to the user that a variable speed mode has been entered. In FIG. 5F, the navigation object displayed is selection object 518. In some embodiments, the navigation object is centered on the finger contact (e.g., navigation object 510 is centered on finger contact 508).

The device detects (608) a second gesture on the touch-sensitive surface with respect to the navigation object. In some embodiments, the second gesture includes moving, on touch screen 112, the finger contact maintained from the first gesture; the second gesture is continuous with the first gesture, in that there is no intervening liftoff of the finger contact, from touch screen 112, between the first and second gestures. For example, in FIG. 5B, the second gesture includes finger contact 508 moving in direction 514. With respect to navigation object 510, finger contact 508 moves away from the center of navigation object 510. As another example, in FIG. 5F, the second gesture includes finger contact 516 moving in direction 520. With respect to selection object 518, finger contact 516 moves away from the center of selection object 518.

In response to detecting the second gesture, the device performs (610) a navigation operation with respect to the first page at a specified velocity and in accordance with a direction of the second gesture, where the velocity of the operation is based on a condition of the second gesture with respect to the navigation object. For example, in FIGS. 5B-5C, in response to the movement of finger contact 508, device 100 performs the navigation operation of navigating from page 500-1 to page 500-2 in accordance with direction 514. The speed at which device 100 navigates from page to page is based on the location of finger contact 508 with respect to navigation object 510. As another example, in FIGS. 5F-5G, in response to the movement of finger contact 516, device 100 performs the navigation operation of moving selection marker 521 from icon 502-1 to icon 502-2 in accordance with direction 520. The speed at which selection marker 521 moves from icon to icon is based on the location of finger contact 516 with respect to selection object 518.

In some embodiments, the first gesture includes tapping and maintaining a finger contact (i.e., tapping with a finger contact and maintaining the contact) at the location on the touch-sensitive surface corresponding to the predefined area, and the second gesture includes moving the maintained finger contact on the touch-sensitive surface (612). For example, in FIGS. 5A-5B, the first gesture includes making finger contact 508 on touch screen 112 at page indicator 504 and maintaining contact 508, and the second gesture includes moving contact 508 in direction 514.

In some embodiments, the device detects (614) a liftoff of the contact, and in response to detecting the liftoff of the contact, ceases (616) the performing. In some embodiments, the navigation operation repeats as long as the finger contact is maintained. When contact lift off is detected, the navigation operation ceases to be performed. Thus, for example, in FIGS. 5B-5D, navigation between pages 500 continues as long as contact 508 is maintained. In FIGS. 5C-5D, device 100 navigates from page 500-2 through zero or more intervening pages 500 to page 500-3. When liftoff of contact 508 is detected, the navigating ceases. For example, in FIG. 5D, contact 508 is no longer detected, and the navigating stops at page 500-3, with page 500-3 being the page displayed at the time of liftoff of contact 508.

In some embodiments, the navigation operation includes navigating from the first page to one or more second pages in the set of pages in sequence and at the specified velocity, including replacing display of one page in the set of pages with display of an adjacent page in the set of pages (i.e., a preceding page or subsequent page in the sequence in the set of pages, depending on the direction of the gesture) (618). For example, as described above with respect to FIGS. 5B-5C, device 100 navigates from page 500-1 to adjacent page 500-2 in the sequence of pages 500, including replacing display of page 500-1 with display of page 500-2.

In some embodiments, the first gesture includes double tapping and maintaining a finger contact (i.e., tapping twice with a finger contact and maintaining the contact on the second tap) at the location on the touch-sensitive surface corresponding to the predefined area, and the second gesture includes moving the maintained finger contact on the touch-sensitive surface (620). For example, in FIGS. 5E-5G, the first gesture includes making a double-tapping finger contact 516 on touch screen 112 at page indicator 504 and maintaining contact 516, and the second gesture includes moving contact 516 in direction 520.

In some embodiments, the first page includes a plurality of icons (e.g., application icons, icons corresponding to content items, etc.) and the navigation operation includes moving a selection marker amongst the plurality of icons at the specified velocity (622). For example, in FIGS. 5E-5G, pages 500 include application icons 502. The navigation operation includes moving a selection marker 521 from one application icon 502 to the next (e.g., from Photos icon 502-1 to Clock icon 502-2) in accordance with direction 520 and at the specified velocity.

In some embodiments, the device detects (624) a liftoff of the contact, and in response to detecting the liftoff of the contact, activates (626) a respective icon having the selection marker. In some embodiments, the navigation operation (e.g., moving selection marker 521) repeats as long as the finger contact is maintained. Thus, for example, in FIGS. 5F-5H, selection marker 521 is moved from one icon 502 to the next as long as contact 516 is maintained. In FIGS. 5G-5H, selection marker 521 moves from Clock icon 502-2 through zero or more intervening icons 502 to Solitaire icon 502-4. When liftoff of contact 516 is detected, selection marker 521 stops moving, and whichever icon 502 selection marker 521 is on at the time the liftoff is detected is activated. For example, in FIG. 5H, selection marker 521 stops at Solitaire icon 502-4 when contact 516 is lifted off, and Solitaire icon 502-4 is activated.

In some embodiments, the second gesture includes moving a finger contact from a location on the touch-sensitive display corresponding to a first location in the navigation object to a location on the touch-sensitive display corresponding to a second location in the navigation object, where the condition of the second gesture with respect to the navigation object includes the distance between the first and second locations in the navigation object (628). In some embodiments, the first location is the center of the navigation object, and thus the condition of the second gesture is a distance of the finger contact from the center of the navigation object. The velocity varies with the distance of the finger contact from the center of the navigation object. For example, in FIGS. 5B-5C, as contact 508 moves further from the center of navigation object 510, the navigation speed increases. As another example, in FIGS. 5F-5G, as contact 516 moves further from the center of navigation object 518, selection marker 530 moves at a faster speed.

In some embodiments, the navigation object corresponds to a plurality of concentric areas, each concentric area corresponding to a respective velocity (630). The first location in the navigation object corresponds to a center of the plurality of concentric areas, and the second location in the navigation object corresponds to a respective concentric area. In some embodiments, each concentric area corresponds to a relative velocity at which the pages are navigated or the selection marker is moved. For example, the centermost area corresponds to a slow velocity, the outermost area corresponds to a fast velocity, and areas in between correspond to velocities in between slow and fast. In some embodiments, the concentric areas demarcate ranges of distance of movement of the finger contact. Each range maps the distance of a finger contact movement to a velocity (e.g., the outermost area, corresponding to a relatively large movement distance, maps to a relatively fast velocity). For example, in FIGS. 5B-5C, concentric areas 512 centered on navigation object 510 are respectively associated with respective navigation speeds. The speed of navigation amongst pages 500 is based on the position of contact 508 with respect to concentric areas 512. As another example, in FIGS. 5F-5G, concentric areas 512 centered on selection object 518 are respectively associated with respective speeds at which selection marker 521 moves. The speed at which selection marker 521 moves is based on the position of contact 516 with respect to concentric areas 512.

In some embodiments, a respective page in the set of pages includes a plurality of icons (632). While displaying the respective page (634), the device detects (636) a third gesture (e.g., a double tap and hold gesture) at the location on the touch-sensitive surface corresponding to a predefined area on the display. In response to detecting the third gesture, the device displays (638) a selection object in proximity to the predefined area. The device detects (640) a fourth gesture (e.g., moving the finger contact from the third gesture on the touch-sensitive surface) on the touch-sensitive surface with respect to the selection object. In response to detecting the fourth gesture, the device moves (642) a selection marker amongst the plurality of icons at a specified velocity and in accordance with a direction of the fourth gesture, where the velocity of the moving is based on a condition of the fourth gesture with respect to the selection object. For example, in FIGS. 5E-5H, page 500-1 includes multiple icons 502. While page 500-1 is displayed, gesture 516 is detected at a location corresponding to page indicator 504. In response detecting to gesture 516, device 100 displays selection object 518 over page indicator 504. Movement 520 of contact 516 is detected with respect to selection object 518. In response to detecting movement of contact 516, selection marker 521 moves amongst icons 502 in accordance with the direction 520 at a specified velocity based on a condition of the movement and position of contact 516 with respect to selection object 518.

It should be understood that the particular order in which the operations in FIGS. 6A-6C have been described is merely exemplary and is not intended to indicate that the described order is the only order in which the operations could be performed. One of ordinary skill in the art would recognize various ways to reorder the operations described herein. Additionally, it should be noted that details of other processes described herein with respect to method 700 (e.g., FIGS. 7A-7B) are also applicable in an analogous manner to method 600 described above with respect to FIGS. 6A-6C. For example, the navigation object 510 and concentric areas 512 described above with reference to method 600 may have one or more of the characteristics of the function object 536 and concentric areas 512 described herein with reference to method 700. For brevity, these details are not repeated here.

FIGS. 7A-7B are flow diagrams illustrating a method 700 of zooming an image preview in accordance with some embodiments. The method 700 is performed at an electronic device (e.g., device 300, FIG. 3, or portable multifunction device 100, FIG. 1) with a display and a touch-sensitive surface. In some embodiments, the display is a touch screen display and the touch-sensitive surface is on the display. In some embodiments, the display is separate from the touch-sensitive surface. In some embodiments, the electronic device includes a camera with optical sensors (e.g., optical sensors 164). Some operations in method 700 may be combined and/or the order of some operations may be changed.

As described below, the method 700 provides an intuitive way to zoom an image preview. The method reduces the cognitive burden on a user when zooming an image preview, thereby creating a more efficient human-machine interface. For battery-operated electronic devices, enabling a user to zoom an image preview faster and more efficiently conserves power and increases the time between battery charges.

The device displays (702) a camera interface on the display, including displaying a live image preview in a viewfinder area in the camera interface. For example, in FIG. 5I, camera interface 522 is displayed. Camera interface 522 includes live preview area 524, where live image preview 532 is displayed.

The device detects (704) a first gesture at a location on the touch-sensitive surface corresponding to a predefined area in the camera interface. For example, in FIG. 5I, gesture 534 is detected at a location on touch screen 112 corresponding to shutter button 526 in camera interface 524.

In response to detecting the first gesture, the device displays (706) a first function object in proximity to the predefined area. For example, in FIG. 5J, in response to detecting gesture 534, function object 536 is displayed over shutter button 526.

The device detects (708) a second gesture on the touch-sensitive surface with respect to the first function object. For example, in FIGS. 5J-5K, contact 534 moves in direction 538 on touch screen 112 with respect to function object 536.

In response to detecting the second gesture, the device zooms (710) the live image preview at a specified velocity and in accordance with a direction of the second gesture, where the velocity of the zooming e.g., how fast the live image preview is zoomed in or out) is based on a condition of the second gesture with respect to the first function object. For example, in FIGS. 5J-5K, in response to the movement 538 of finger contact 534, live image preview 532 is zoomed in accordance with direction 538.

In some embodiments, the first gesture includes tapping and maintaining a finger contact (i.e., making finger contact with the touch-sensitive surface and maintaining the contact) at the location on the touch-sensitive surface corresponding to the predefined area, and the second gesture includes moving the maintained finger contact on the touch-sensitive surface (712). For example, in FIGS. 5I-5K, the first gesture includes gesture 534 on shutter button 526, and the second gesture includes contact 534 moving in direction 538.

In some embodiments, the device detects (714) a liftoff of the finger contact, and, in response to detecting the liftoff, ceases (716) the zooming. For example, in FIG. 5L, liftoff of finger contact 534 is detected, and in response, zooming of live image preview 532 is ceased.

In some embodiments, the second gesture includes moving a finger contact from a location on the touch-sensitive display corresponding to a first location in the first function object to a location on the touch-sensitive display corresponding to a second location in the first function object, where the condition of the second gesture with respect to the first function object includes the distance between the first and second locations in the first function object (718). In some embodiments, the first location is the center of the function object, and thus the condition of the second gesture is a distance of the finger contact from the center of the function object. The velocity varies with the distance of the finger contact from the center of the function object. For example, in FIGS. 5J-5K, as contact 534 moves further from the center of function object 536, the zooming speed increases.

In some embodiments, the first function object corresponds to a plurality of concentric areas, each concentric area corresponding to a respective velocity, the first location in the first function object corresponds to a center of the plurality of concentric areas, and the second location in the first function object corresponds to a respective concentric area (720). In some embodiments, each concentric area corresponds to a relative velocity at which the live image preview is zoomed. For example, the centermost area corresponds to a slow velocity, the outermost area corresponds to a fast velocity, and areas in between corresponds to velocities in between slow and fast. In some embodiments, the concentric areas demarcate ranges of distance of movement of the finger contact. Each range maps the distance of a finger contact movement to a velocity (e.g., the outermost area, corresponding to a relatively large movement distance, maps to a relatively fast velocity). For example, in FIGS. 5J-5K, concentric areas 512 centered on function object 536 are respectively associated with respective zooming speeds. The zooming speed is based on the position of contact 534 with respect to concentric areas 512.

In some embodiments, the device detects (722) one or more focus objects within the live image preview. For example, in FIGS. 5M-5O, one or more focus objects in live image preview 532 are detected. The focus objects may be, for example, objects (e.g., window 547, FIG. 5N; tree 551, FIG. 5P) or faces of people or animals.

The device detects (724) a third gesture (e.g., a double tap and hold gesture) at the location on the touch-sensitive surface corresponding to the predefined area in the camera interface. In response to detecting the third gesture, the device displays (726) a second function object in proximity to the predefined area. For example, in FIGS. 5M-5N, gesture 544 is detected on shutter button 526. In response to detecting gesture 544, device 100 displays function object 545 over shutter button 526.

The device detects (728) a fourth gesture (e.g., moving the finger contact from the third gesture on the touch-sensitive surface) on the touch-sensitive surface with respect to the second function object. For example, in FIGS. 5N-5O, movement of contact 544 is detected.

In some embodiments, the third gesture includes double tapping and maintaining a finger contact (i.e., tapping twice and maintaining that contact on the second tap) at the location on the touch-sensitive surface corresponding to the predefined area, and where the fourth gesture includes moving the maintained finger contact on the touch-sensitive surface (730). For example, in FIGS. 5M-5O, the third gesture includes making a double-tapping finger contact 544 on touch screen 112 at shutter button 526 and maintaining contact 544, and the second gesture includes moving contact 544 in direction 548.

In response to detecting the fourth gesture, the device moves (732) a focus indicator amongst the focus objects at a specified velocity and in a sequence in accordance with a direction of the fourth gesture, where the velocity of the moving is based on a condition of the fourth gesture with respect to the second function object. For example, in response to detecting movement of contact 544, focus object marker 546 is moved amongst the detected focus objects (e.g., windows 547, 549; tree 551) in live image preview 532 at a speed based on a condition of the fourth gesture with respect to the second function object (e.g., position of contact 544 with respect to a center of function object 545; position of contact 544 with respect to concentric areas 512 centered on function object 545).

In some embodiments, the device detects (734) a liftoff of the finger contact; and in response to detecting the liftoff, captures (736) an image focused on the focus object having the focus indicator. For example, in FIG. 5P, liftoff of contact 544 is detected. In response, an image based on live image preview 532 is captured with the focus on tree 551 indicated by focus object marker 546.

It should be understood that the particular order in which the operations in FIGS. 7A-7B have been described is merely exemplary and is not intended to indicate that the described order is the only order in which the operations could be performed. One of ordinary skill in the art would recognize various ways to reorder the operations described herein. Additionally, it should be noted that details of other processes described herein with respect to method 600 (e.g., FIGS. 6A-6C) are also applicable in an analogous manner to method 700 described above with respect to FIGS. 7A-7B. For example, the function object 536 and concentric areas 512 described above with reference to method 700 may have one or more of the characteristics of the navigation object 510 and concentric areas 512 described herein with reference to method 600. For brevity, these details are not repeated here.

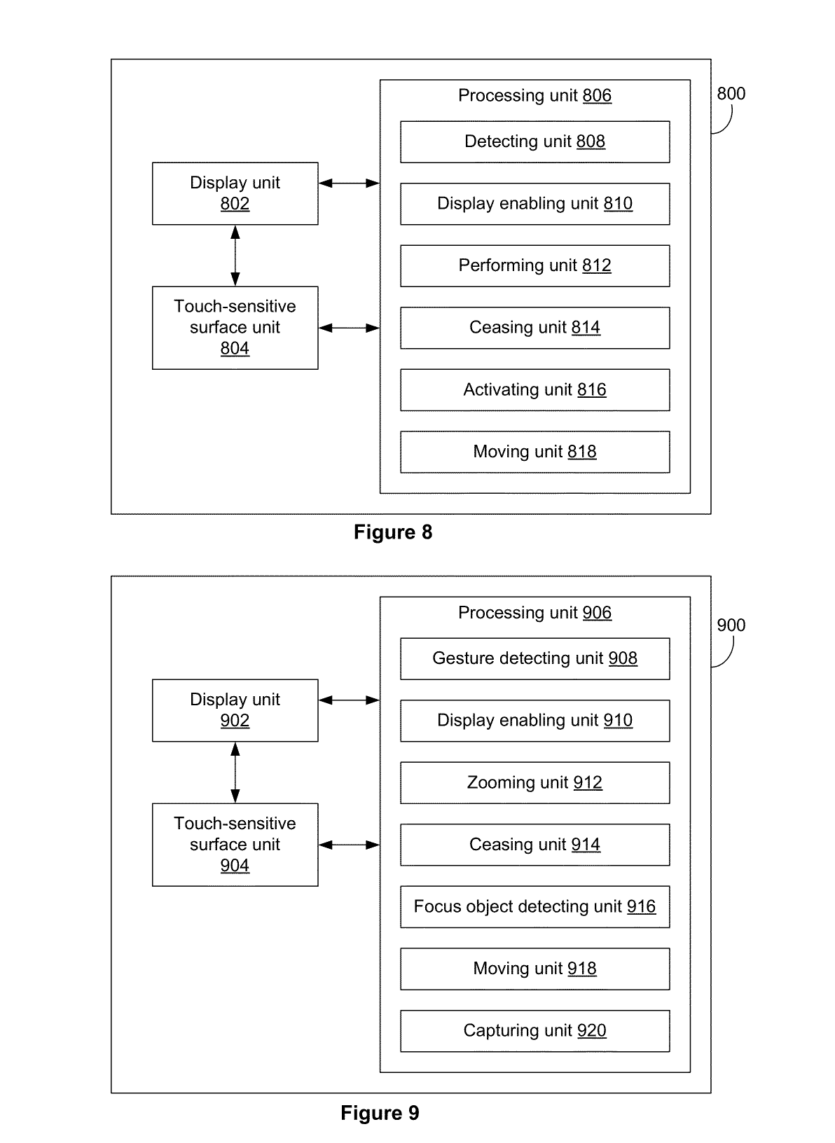

In accordance with some embodiments, FIG. 8 shows a functional block diagram of an electronic device 800 configured in accordance with the principles of the invention as described above. The functional blocks of the device may be implemented by hardware, software, or a combination of hardware and software to carry out the principles of the invention. It is understood by persons of skill in the art that the functional blocks described in FIG. 8 may be combined or separated into sub-blocks to implement the principles of the invention as described above. Therefore, the description herein may support any possible combination or separation or further definition of the functional blocks described herein.

As shown in FIG. 8, an electronic device 800 includes a display unit 802 configured to display a first page in a set of pages; a touch-sensitive surface unit 804 configured to receive gestures; and a processing unit 806 coupled to the display unit 802 and the touch-sensitive surface unit 804. In some embodiments, the processing unit 806 includes a detecting unit 808, a display enabling unit 810, a performing unit 812, a ceasing unit 814, an activating unit 816, and a moving unit 818.

The processing unit 806 is configured to detect a first gesture at a location on the touch-sensitive surface unit 804 corresponding to a predefined area on the display unit 802 (e.g., with the detecting unit 808); in response to detecting the first gesture, enable display of a navigation object in proximity to the predefined area (e.g., with the display enabling unit 810); detect a second gesture on the touch-sensitive surface unit 804 with respect to the navigation object (e.g., with the detecting unit 808); and in response to detecting the second gesture, perform a navigation operation with respect to the first page at a specified velocity and in accordance with a direction of the second gesture, wherein the velocity of the operation is based on a condition of the second gesture with respect to the navigation object (e.g., with the performing unit 812).

In some embodiments, the first gesture comprises tapping and maintaining a finger contact at the location on the touch-sensitive surface unit 804 corresponding to the predefined area, and wherein the second gesture comprises moving the maintained finger contact on the touch-sensitive surface unit 804.

In some embodiments, the processing unit 806 is configured to detect a liftoff of the finger contact (e.g., with the detecting unit 808), and, in response to detecting the liftoff, cease the performing (e.g., with the ceasing unit 814).

In some embodiments, the navigation operation includes navigating from the first page to one or more second pages in the set of pages in sequence and at the specified velocity, including replacing display of one page in the set of pages with display of an adjacent page in the set of pages.

In some embodiments, the first gesture comprises double tapping and maintaining a finger contact at the location on the touch-sensitive surface unit 804 corresponding to the predefined area, and wherein the second gesture comprises moving the maintained finger contact on the touch-sensitive surface unit 804.

In some embodiments, the first page includes a plurality of icons, and the navigation operation includes moving a selection marker amongst the plurality of icons at the specified velocity.

In some embodiments, the processing unit 806 is configured to detect a liftoff of the finger contact (e.g., with the detecting unit 808), and, in response to detecting the liftoff, activate a respective icon having the selection marker (e.g., with the activating unit 816).

In some embodiments, the second gesture comprises moving a finger contact from a location on the touch-sensitive surface unit 804 corresponding to a first location in the navigation object to a location on the touch-sensitive surface unit 804 corresponding to a second location in the navigation object, wherein the condition of the second gesture with respect to the navigation object comprises the distance between the first and second locations in the navigation object.

In some embodiments, the navigation object corresponds to a plurality of concentric areas, each concentric area corresponding to a respective velocity, the first location in the navigation object corresponds to a center of the plurality of concentric areas, and the second location in the navigation object corresponds to a respective concentric area.

In some embodiments, a respective page in the set of pages includes a plurality of icons, and wherein the processing unit 806 is configured to: while displaying the respective page, detect a third gesture at the location on the touch-sensitive surface unit 804 corresponding to a predefined area on the display unit 802 (e.g., with the detecting unit 808), in response to detecting the third gesture, display a selection object in proximity to the predefined area (e.g., with the display enabling unit 810), detect a fourth gesture on the touch-sensitive surface unit 804 with respect to the selection object (e.g., with the detecting unit 808), and in response to detecting the fourth gesture, move a selection marker amongst the plurality of icons at a specified velocity and in accordance with a direction of the fourth gesture, wherein the velocity of the moving is based on a condition of the fourth gesture with respect to the selection object (e.g., with the moving unit 818).

In accordance with some embodiments, FIG. 9 shows a functional block diagram of an electronic device 900 configured in accordance with the principles of the invention as described above. The functional blocks of the device may be implemented by hardware, software, or a combination of hardware and software to carry out the principles of the invention. It is understood by persons of skill in the art that the functional blocks described in FIG. 9 may be combined or separated into sub-blocks to implement the principles of the invention as described above. Therefore, the description herein may support any possible combination or separation or further definition of the functional blocks described herein.

As shown in FIG. 9, an electronic device 900 includes a display unit 902 configured to display a camera interface, including a live image preview in a viewfinder area in the camera interface; a touch-sensitive surface unit 904 configured to receive gestures; and a processing unit 906 coupled to the display unit 902 and the touch-sensitive surface unit 904. In some embodiments, the processing unit 906 includes a gesture detecting unit 908, a display enabling unit 910, a zooming unit 912, a ceasing unit 814, focus object detecting unit 916, a moving unit 918, and a capturing unit 920.

The processing unit 906 is configured to detect a first gesture at a location on the touch-sensitive surface unit 904 corresponding to a predefined area in the camera interface (e.g., with the gesture detecting unit 908); in response to detecting the first gesture, enable display of a first function object in proximity to the predefined area (e.g., with the display enabling unit 910); detect a second gesture on the touch-sensitive surface unit 904 with respect to the first function object (e.g., with the gesture detecting unit 908); and in response to detecting the second gesture, zoom the live image preview at a specified velocity and in accordance with a direction of the second gesture, wherein the velocity of the zooming is based on a condition of the second gesture with respect to the first function object (e.g., with the zooming unit 912).

In some embodiments, the first gesture comprises: tapping and maintaining a finger contact at the location on the touch-sensitive surface unit 904 corresponding to the predefined area, and wherein the second gesture comprises moving the maintained finger contact on the touch-sensitive surface unit 904.

In some embodiments, the processing unit 906 is configured to detect a liftoff of the finger contact (e.g., with the gesture detecting unit 908); and, in response to detecting the liftoff, cease the zooming (e.g., with the ceasing unit 914).

In some embodiments, the second gesture comprises moving a finger contact from a location on the touch-sensitive surface unit 904 corresponding to a first location in the first function object to a location on the touch-sensitive surface unit 904 corresponding to a second location in the first function object, wherein the condition of the second gesture with respect to the first function object comprises the distance between the first and second locations in the first function object.

In some embodiments, the first function object corresponds to a plurality of concentric areas, each concentric area corresponding to a respective velocity; the first location in the first function object corresponds to a center of the plurality of concentric areas; and the second location in the first function object corresponds to a respective concentric area.

In some embodiments, the processing unit 906 is configured to detect one or more focus objects within the live image preview (e.g., with the focus object detecting unit 916); detecting a third gesture at the location on the touch-sensitive surface unit 904 corresponding to the predefined area in the camera interface (e.g., with the gesture detecting unit 908); in response to detecting the third gesture, displaying a second function object in proximity to the predefined area (e.g., with the display enabling unit 910); detecting a fourth gesture on the touch-sensitive surface unit 904 with respect to the second function object (e.g., with the gesture detecting unit 908); and in response to detecting the fourth gesture, moving a focus indicator amongst the focus objects at a specified velocity and in a sequence in accordance with a direction of the fourth gesture, wherein the velocity of the moving is based on a condition of the fourth gesture with respect to the second function object (e.g., with the moving unit 918).

In some embodiments, the third gesture comprises double tapping and maintaining a finger contact at the location on the touch-sensitive surface unit 904 corresponding to the predefined area, and wherein the fourth gesture comprises moving the maintained finger contact on the touch-sensitive surface unit 904.

In some embodiments, the processing unit 906 is configured to detect a liftoff of the finger contact (e.g., with the gesture detecting unit 908); and in response to detecting the liftoff, capture an image focused on the focus object having the focus indicator (e.g., with the capturing unit 920).

The operations in the information processing methods described above may be implemented by running one or more functional modules in information processing apparatus such as general purpose processors or application specific chips. These modules, combinations of these modules, and/or their combination with general hardware (e.g., as described above with respect to FIGS. 1A and 3) are all included within the scope of protection of the invention.

The operations described above with reference to FIGS. 6A-6C, 7A-7B may be implemented by components depicted in FIGS. 1A-1B. For example, detection operation 604, displaying operation 606, and performing operation 610 may be implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface corresponds to a predefined event or sub-event, such as selection of an object on a user interface. When a respective predefined event or sub-event is detected, event recognizer 180 activates an event handler 190 associated with the detection of the event or sub-event. Event handler 190 may utilize or call data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. An electronic device, comprising:
a display;
a touch-sensitive surface;
one or more processors;
memory; and
one or more programs, wherein the one or more programs are stored in the memory and configured to be executed by the one or more processors, the one or more programs including instructions for:
displaying a first page in a set of pages on the display;
detecting a first gesture at a location on the touch-sensitive surface corresponding to a predefined area on the display;
in response to detecting the first gesture, displaying a navigation object in proximity to the predefined area;
detecting a second gesture on the touch-sensitive surface with respect to the navigation object; and
in response to detecting the second gesture, performing a navigation operation with respect to the first page at a specified velocity and in accordance with a direction of the second gesture, wherein the velocity of the operation is based on a condition of the second gesture with respect to the navigation object.

2. The device of claim 1, wherein the first gesture comprises tapping and maintaining a finger contact at the location on the touch-sensitive surface corresponding to the predefined area, and
wherein the second gesture comprises moving the maintained finger contact on the touch-sensitive surface.

3. The device of claim 2, including instructions for:
detecting a liftoff of the finger contact; and
in response to detecting the liftoff, ceasing the performing.

4. The device of claim 1, wherein the navigation operation includes navigating from the first page to one or more second pages in the set of pages in sequence and at the specified velocity, including replacing display of one page in the set of pages with display of an adjacent page in the set of pages.

5. The device of claim 1, wherein the first gesture comprises double tapping and maintaining a finger contact at the location on the touch-sensitive surface corresponding to the predefined area, and
wherein the second gesture comprises moving the maintained finger contact on the touch-sensitive surface.

6. The device of claim 5, wherein the first page includes a plurality of icons, and the navigation operation includes moving a selection marker amongst the plurality of icons at the specified velocity.

7. The device of claim 6, including instructions for:
detecting a liftoff of the finger contact; and
in response to detecting the liftoff, activating a respective icon having the selection marker.

8. The device of claim 1, wherein the second gesture comprises moving a finger contact from a location on the touch-sensitive surface corresponding to a first location in the navigation object to a location on the touch-sensitive surface corresponding to a second location in the navigation object, and
wherein the condition of the second gesture with respect to the navigation object comprises the distance between the first and second locations in the navigation object.

9. The device of claim 8, wherein:
the navigation object corresponds to a plurality of concentric areas, each concentric area corresponding to a respective velocity;
the first location in the navigation object corresponds to a center of the plurality of concentric areas; and
the second location in the navigation object corresponds to a respective concentric area.

10. The device of claim 1, wherein a respective page in the set of pages includes a plurality of icons, the device including instructions for
while displaying the respective page:
detecting a third gesture at the location on the touch-sensitive surface corresponding to a predefined area on the display;
in response to detecting the third gesture, displaying a selection object in proximity to the predefined area;
detecting a fourth gesture on the touch-sensitive surface with respect to the selection object; and
in response to detecting the fourth gesture, moving a selection marker amongst the plurality of icons at a specified velocity and in accordance with a direction of the fourth gesture, wherein the velocity of the moving is based on a condition of the fourth gesture with respect to the selection object.

11. An electronic device, comprising:
a display;
a touch-sensitive surface;
one or more processors;
memory; and
one or more programs, wherein the one or more programs are stored in the memory and configured to be executed by the one or more processors, the one or more programs including instructions for:
displaying a camera interface on the display, including displaying a live image preview in a viewfinder area in the camera interface;
detecting a first gesture at a location on the touch-sensitive surface corresponding to a predefined area in the camera interface;
in response to detecting the first gesture, displaying a first function object in proximity to the predefined area;
detecting a second gesture on the touch-sensitive surface with respect to the first function object; and,
in response to detecting the second gesture, zooming the live image preview at a specified velocity and in accordance with a direction of the second gesture, wherein the velocity of the zooming is based on a condition of the second gesture with respect to the first function object.

12. The device of claim 11, wherein the first gesture comprises tapping and maintaining a finger contact at the location on the touch-sensitive surface corresponding to the predefined area, and
wherein the second gesture comprises moving the maintained finger contact on the touch-sensitive surface.

13. The device of claim 12, including instructions for:
detecting a liftoff of the finger contact; and
in response to detecting the liftoff, ceasing the zooming.

14. The device of claim 11, wherein the second gesture comprises moving a finger contact from a location on the touch-sensitive surface corresponding to a first location in the first function object to a location on the touch-sensitive surface corresponding to a second location in the first function object, and
wherein the condition of the second gesture with respect to the first function object comprises the distance between the first and second locations in the first function object.

15. The device of claim 14, wherein:
the first function object corresponds to a plurality of concentric areas, each concentric area corresponding to a respective velocity;
the first location in the first function object corresponds to a center of the plurality of concentric areas; and
the second location in the first function object corresponds to a respective concentric area.

16. The device of claim 11, including instructions for:
detecting one or more focus objects within the live image preview;
detecting a third gesture at the location on the touch-sensitive surface corresponding to the predefined area in the camera interface;
in response to detecting the third gesture, displaying a second function object in proximity to the predefined area;
detecting a fourth gesture on the touch-sensitive surface with respect to the second function object; and,
in response to detecting the fourth gesture, moving a focus indicator amongst the focus objects at a specified velocity and in a sequence in accordance with a direction of the fourth gesture, wherein the velocity of the moving is based on a condition of the fourth gesture with respect to the second function object.

17. The device of claim 16, wherein the third gesture comprises double tapping and maintaining a finger contact at the location on the touch-sensitive surface corresponding to the predefined area, and
wherein the fourth gesture comprises moving the maintained finger contact on the touch-sensitive surface.

18. The device of claim 17, including instructions for:
detecting a liftoff of the finger contact; and
in response to detecting the liftoff, capturing an image focused on the focus object having the focus indicator.

19. A computer readable storage medium storing one or more programs, the one or more programs comprising instructions, which when executed by an electronic device with a display and a touch-sensitive surface, cause the device to:
display a first page in a set of pages on the display;
detect a first gesture at a location on the touch-sensitive surface corresponding to a predefined area on the display;
in response to detecting the first gesture, display a navigation object in proximity to the predefined area;
detect a second gesture on the touch-sensitive surface with respect to the navigation object; and
in response to detecting the second gesture, perform a navigation operation with respect to the first page at a specified velocity and in accordance with a direction of the second gesture, wherein the velocity of the operation is based on a condition of the second gesture with respect to the navigation object.

20. A computer readable storage medium storing one or more programs, the one or more programs comprising instructions, which when executed by an electronic device with a display and a touch-sensitive surface, cause the device to:
display a camera interface on the display, including display a live image preview in a viewfinder area in the camera interface;
detect a first gesture at a location on the touch-sensitive surface corresponding to a predefined area in the camera interface;
in response to detecting the first gesture, display a first function object in proximity to the predefined area;
detect a second gesture on the touch-sensitive surface with respect to the first function object; and
in response to detecting the second gesture, zoom the live image preview at a specified velocity and in accordance with a direction of the second gesture, wherein the velocity of the zooming is based on a condition of the second gesture with respect to the first function object.
